(19) United States
(12) Patent Application Publication
(10) Pub. No.: US 2026/0020617 A1
(43) Pub. Date: Jan. 22, 2026

(54) A METHOD OF CONTROLLING OVERHEATING IN AN AEROSOL-GENERATING SYSTEM

(71) Applicant: Philip Morris Products S.A., Neuchatel (CH)

(72) Inventors: Stéphane BILAT, Cortaillod (CH); Enrico STURA, Palézieux-Village (CH)

(73) Assignee: Philip Morris Products S.A., Neuchatel (CH)

(21) Appl. No.: 18/996,344

(22) PCT Filed: Jul. 27, 2023
(86) PCT No.: PCT/EP2023/070917

§ 371 Date: Jan. 17, 2025

(30) Foreign Application Priority Data
Aug. 11, 2022 (EP) 22189971.9

(51) Int. Cl. A24F 40/57; A24F 40/10; A24F 40/465; A24F 40/51; A24F 40/53; H05B 6/10

(52) U.S. Cl. CPC A24F 40/57; A24F 40/10; A24F 40/465; A24F 40/51; A24F 40/53; H05B 6/108

(57) ABSTRACT

A method is provided of controlling heating in an aerosol-generating system including a heating element configured to heat a liquid aerosol-forming substrate supplied to the element, the method including: providing a supply of power to the element; monitoring an electrical parameter indicating a temperature of the element; determining whether the electrical parameter is greater than a maximum threshold value or less than a minimum threshold value indicating that a threshold temperature of the element has been exceeded; interrupting the supply of power to the element when the threshold temperature is exceeded to allow the element to cool to a temperature at which the electrical parameter is below the maximum threshold value or above the minimum threshold value; following cooling, determining whether the element is supplied with the liquid aerosol-forming substrate; and disabling the supply of power if the element is not supplied with the liquid aerosol-forming substrate.

The present disclosure relates to method of controlling heating in an aerosol-generating system. In particular, but not exclusively, the present disclosure relates to a method of controlling heating in a handheld electrically operated aerosol-generating system for heating an aerosol-forming substrate to generate an aerosol and for delivering the aerosol into the mouth of a user. The present disclosure further relates to an aerosol-generating system having control circuitry configured to perform the method of controlling heating.

Aerosol-generating systems that heat a liquid aerosol-forming substrate in order to generate an aerosol for delivery to a user are generally known in the prior art. These systems typically comprise an aerosol-generating device and a cartridge, which is configured to be removably couplable to the aerosol-generating device. The cartridge includes a liquid aerosol-forming substrate that is capable of releasing volatile compounds when heated. The cartridge typically also includes a heater for heating the liquid aerosol-forming substrate. In known aerosol-generating systems, the heater comprises a resistive heating element that is supplied with liquid aerosol-forming substrate by some form of wick. The aerosol-generating device or cartridge also comprises a mouthpiece. When a user takes a puff on the mouthpiece, an electric current is passed through the heating element causing it to be heated by resistive or Joule heating, which, in turn, heats the liquid aerosol-forming substrate supplied by the wick. This causes volatile compounds to be released from the liquid aerosol-forming substrate that cool to form an aerosol. The aerosol is then drawn into a user's mouth via the mouthpiece.

Typically, the aerosol-generating device is reusable, and the liquid aerosol-forming substrate is contained in a disposable cartridge. After a period of use, for example, a predetermined number of puffs by a user, the liquid aerosol-forming substrate will become depleted. Once the liquid aerosol-forming substrate is depleted, the cartridge should be replaced before subsequent use of the aerosol-generating device.

During operation, it is preferable to maintain a supply of liquid aerosol-forming substrate to the heating element such that the heating element is maintained in a wet state because this helps to ensure that a satisfactory aerosol is produced when a user takes a puff. A wet heating element also helps to regulate the temperature of the heating element because the heat generated in the heating element is transferred to the liquid aerosol-forming substrate and dissipated in the generated aerosol, which stops the heating element from overheating and helps to maintain the heating element at a predetermined threshold temperature. If the heating element rises above the predetermined threshold temperature, then this may be indicative of a “dry heating” or “dry puff” situation, that is, a situation in which the heating element is heated with insufficient liquid aerosol-forming substrate being present reducing the amount of heat dissipated in the aerosol. This can result in overheating and, potentially, thermal decomposition of the liquid aerosol-forming substrate, which can produce undesirable by-products and an unsatisfactory aerosol. This may result in a poor user experience.

However, a dry heating situation can arise from two different causes. The first cause is the liquid aerosol-forming substrate in the cartridge has been completely depleted and therefore no liquid aerosol-forming substrate can be supplied to the heating element. In this case, the cartridge needs to be replaced. The second cause is that the user has temporarily dried the heating element by taking a particularly strong or long puff. In this case, the cartridge is not completely depleted and the user still has a number of puffs to be consumed. Therefore, the cartridge does not need to be replaced but time needs to be allowed for the liquid aerosol-forming substrate to rewet the heating element. Prior to the examples set out in the present disclosure, it has been problematic for an aerosol-generating system to distinguish between the above two causes of a dry heating situation.

It would be desirable to provide a method of detecting and controlling a dry heating situation and reducing the production of unwanted by-products. It would be desirable to provide a method which can distinguish between a dry heating situation that arises due to cartridge or other supply of liquid aerosol-forming substrate being completely depleted and a dry heating situation that arises due to a user taking a particularly strong or long puff which has only temporarily dried the heating element.

According to an example of the present disclosure, there is provided a method of controlling heating in an aerosol-generating system. The aerosol-generating system may comprise a heating element for heating a liquid aerosol-forming substrate supplied to the heating element. The method may comprise providing a supply of power to the heating element. The method may comprise monitoring an electrical parameter. The electrical parameter may indicate a temperature of the heating element. The method may comprise determining whether the electrical parameter is greater than a maximum threshold value or less than a minimum threshold value indicating that a threshold temperature of the heating element has been exceeded. The method may comprise interrupting the supply of power to the heating element when the threshold temperature is exceeded. The method may comprise allowing the heating element to cool to a temperature at which the electrical parameter is below the maximum threshold value or above the minimum threshold value. The method may comprise, following cooling, determining whether the heating element is supplied with the liquid aerosol-forming substrate. The method may comprise disabling the supply of power if the heating element is not supplied with the liquid aerosol-forming substrate.

According to an example of the present disclosure, there is provided a method of controlling heating in an aerosol-generating system comprising a heating element for heating a liquid aerosol-forming substrate supplied to the heating element. The method comprises providing a supply of power to the heating element. The method comprises monitoring an electrical parameter indicating a temperature of the heating element. The method comprises determining whether the electrical parameter is greater than a maximum threshold value or less than a minimum threshold value indicating that a threshold temperature of the heating element has been exceeded. The method comprises interrupting the supply of power to the heating element when the threshold temperature is exceeded to allow the heating element to cool to a temperature at which the electrical parameter is below the maximum threshold value or above the minimum threshold value. The method comprises, following cooling, determining whether the heating element is supplied with the liquid aerosol-forming substrate. The method comprises disabling the supply of power if the heating element is not supplied with the liquid aerosol-forming substrate.

Advantageously, the above method allows the aerosol-generating system to detect and control the occurrence of an overheating or dry heating situation. By interrupting the supply of power when an overheating or drying heating situation is detected, the method reduces the likelihood of unwanted by-products being produced and the user receiving a poor user experience. Furthermore, by allowing the heating element to cool to a temperature below the threshold temperature, the method can more accurately determine whether the heating element is supplied with liquid aerosol-forming substrate. At temperatures above the threshold temperature, any liquid aerosol-forming substrate that is resupplied to the heating element after a dry heating situation may be immediately aerosolised making it more difficult to determine whether there is liquid aerosol-forming substrate remaining. However, at temperatures below the threshold temperature, the heating element will not immediately aerosolise the liquid aerosol-forming substrate, allowing the heating element to be rewetted and the presence of liquid aerosol-forming substrate to be more accurately detected. In addition, by determining whether the heating element is supplied with liquid aerosol-forming substrate following cooling, the method allows the aerosol-generating system to accurately distinguish between a dry heating situation arising as a result of the liquid aerosol-forming substrate being completely depleted or as a result of a user taking a particularly strong or prolonged puff.

As used herein, the term “threshold temperature” refers to a temperature above the normal operation or aerosolization temperature of the heating element. If the heating element is operating at temperatures above the threshold temperature, it may be indicative that an overheating or drying heating situation is occurring. As used herein, when referring to the electrical parameter, the term “threshold value” means a value of the electrical parameter corresponding to the threshold temperature.

As used herein, the term “electrical parameter” refers to an electrical property or characteristic, including but not being limited to, a voltage or potential difference, an electric current or an electrical resistance. The electrical parament can be monitored by measuring the parameter directly such as a voltage or can be determined indirectly from another electrical parameter or parameters, for example, an electrical resistance can be determined using Ohm's Law by firstly determining a voltage across a component and an electric current through the component and dividing the voltage by the current.

The electrical parameter is indicative of a temperature of the heating element. In the above method, an electrical parameter is selected which has relationship with temperature. This may be either a known relationship with temperature or a relationship that can be determined. For example, it is known that electrical resistance varies with temperature and can be determined by the temperature coefficient of resistance which describes how the electrical resistance of a component changes with respect to a change in temperature. Over a certain temperature range, the change in resistance may vary approximately linearly with temperature, which can make the determination of temperature at a certain measured resistance relatively straightforward. Alternatively, the relationship between an electrical parameter and temperature can be determined, for example, by experiment and the temperature corresponding to certain values of the parameter can be stored in memory such as in a look-up table.

The monitored electrical parameter could be an electrical parameter of the heating element itself. For example, the method may determine the electrical resistance of the heating element itself. Alternatively, the method may determine an electrical parameter of a component connected to the heating element. For example, the method may determine an electrical current of a resistor connected in series with the heating element. The electrical current passing through two components connected in series is the same. Since electrical current is related to electrical resistance, which is, in turn, related to temperature, the electrical current through the resistor would provide an indication of the temperature of the heating element.

Some electrical parameters exhibit a positive relationship with changing temperature, that is, when temperature increases the electrical parameter also increases. This is the generally the case with electrical resistance, particularly over the operating temperature range of aerosol-generating systems. Accordingly, as the temperature of the heating element of the aerosol-generating system increases, the resistance of the heating element also increases. Therefore, when determining whether a temperature threshold of the heating element has been exceeded, it determines whether the resistance of the heating element is greater than a maximum threshold value.

Conversely, some electrical parameters exhibit a negative relationship with changing temperature, that is, when temperature increases the electrical parameter decreases. This is the generally the case with electrical conductance, particularly over the operating temperature range of aerosol-generating systems. Electrical conductance is the reciprocal of electrical resistance. Accordingly, as the temperature of the heating element of the aerosol-generating system increases, the conductance of the heating element would decrease. Therefore, when determining whether a temperature threshold of the heating element has been exceeded, it determines whether the conductance of the heating element is less than a minimum threshold value.

The method may further comprise determining an initial value of the electrical parameter. The step of determining whether the electrical parameter is greater than a maximum threshold value or less than a minimum threshold value may comprise determining whether a ratio between the initial value and a change in the value of the monitored electrical parameter is greater than a maximum threshold value or less than a minimum threshold value. Advantageously, determining an initial value of the electrical parameter can help to account for different initial temperatures of the heating element, for example, if the aerosol-generating system is being used in environments having different ambient temperatures. Determining a ratio between the initial value of the electrical parameter and a change in the value of the electrical parameter has been found to be another effective way of determining whether a threshold temperature of the heating element has been exceeded. Furthermore, the ratio may provide an indication of the significance of the change which may then be used to more effectively control the heating element. The ratio may be a percentage.

The method may further comprise resuming the supply of power if the heating element is supplied with the liquid aerosol-forming substrate. Advantageously, resuming the supply of power if the heating element is supplied with the liquid aerosol-forming substrate reduces the interruption to the operation of the aerosol-generating system to a minimum and allows a user to continue safely with their user experience.

The method may further comprise the step of detecting a user puff before providing a supply of power to the heating element. This means that power is only supplied to the heating element when a user is actively using the aerosol-generating system, which helps to improve the energy efficiency of the system. Furthermore, it may help reduce the likelihood of overheating by avoiding unnecessarily heating the heating element.

Monitoring the electrical parameter may comprise monitoring an electrical resistance of the heating element. The method may comprise determining whether the electrical resistance is greater than a maximum threshold value indicating that a threshold temperature of the heating element has been exceeded. As discussed above, electrical resistance has a positive relationship with temperature, that is, as the temperature of the heating element increases, the resistance of the heating element also increases. Accordingly, when determining whether a temperature threshold of the heating element has been exceeded, it determines whether the resistance of the heating element is greater than a maximum threshold value.

The aerosol-generating system performing the method may be an inductive aerosol-generating system. The aerosol-generating system may comprise an inductor. The heating element may comprise a susceptor arranged to be heated by the inductor. Monitoring an electrical resistance of the heating element may comprises monitoring an equivalent resistance of the inductor. The term equivalent resistance is defined below when discussing the aerosol-generating system.

The method may further comprise the step of monitoring the cooling of the heating element. Advantageously, by monitoring the cooling of the heating element, the method can determine when the temperature of the heating element has cooled to a temperature below the threshold temperature as soon as it occurs which allows the next step in the method, that is, determining whether the heating element is supplied with liquid aerosol-forming substrate, to be performed promptly. This helps to improve the responsiveness of the method. Furthermore, the rate at which the heating element cools can provide an indication of whether the heating element is supplied with liquid aerosol-forming substrate, as discussed below.

Monitoring of the cooling of the heating element may comprise providing a probing pulse to the heating element and determining an electrical resistance of the heating element during the probing pulse. As used herein, the term “probing pulse” refers to a test pulse having significantly less power than full power operation when the heating element is being heated. A probing pulse may last a significantly shorter period of time than pulses provided during full power operation. A probing pulse may typically constitute less than 10 percent of full power operation, preferably less than 7 percent of full power operation, and more preferably less than or equal to 5 percent of full power operation. Such a low amount of power is not capable of heating the heating element. However, a probing pulse still provides sufficient power for an electrical parameter such as a resistance of the heating element to be determined and provide an indication of the temperature of the heating element. Using a pulse has been found to be a particularly efficient method of monitoring the cooling the heating element since it does not consume very much power.

Monitoring of the cooling of the heating element may comprise providing a plurality of probing pulses to the heating element and monitoring an electrical resistance of the heating element over successive probing pulses. Each probing pulse may typically constitute less than 10 percent of full power operation, preferably less than 7 percent of full power operation, and more preferably less than or equal to 5 percent of full power operation. The combined power of the plurality of probing pulses is not capable of heating the heating element but allows the temperature of the heating element to be tracked as it cools and the point at which the temperature of the heating element drops below the threshold temperature can be identified more quickly than if a single pulse were used.

A probing pulse may have any suitable duration. Where two or more probing pulses are supplied to the heating element, each probing pulse may have a substantially similar duration. The duration of each probing pulse may be substantially equal to a probing pulse duration. The probing pulse duration may be stored in a memory. The probing pulse duration may be between about 2 milliseconds and about 20 milliseconds or between about 5 milliseconds and about 15 milliseconds. The probing pulse duration may be about 10 milliseconds.

Where two or more probing pulses are supplied to the heating element, successive probing pulses may be separated by a probing pulse time interval. The probing pulse time interval may be a predetermined value. The probing pulse time interval may be stored in a memory. Typically, the probing pulse time interval duration is longer than the probing pulse duration to reduce the likelihood of the cumulative effect of successive probing pulses heating the heating element. The probing pulse time interval may be substantially constant or fixed. The probing pulse time interval may be between about 50 milliseconds and about 50 milliseconds or between about 70 milliseconds and about 120 milliseconds. The probing pulse time interval duration may be about 90 milliseconds.

The step of determining whether the heating element is supplied with liquid aerosol-forming substrate may comprise monitoring the rate of cooling of the heating element. When liquid aerosol-forming substrate is supplied to the heating element, it has a cooling effect on the heating element. The rate of cooling of the heating element may therefore be higher when liquid aerosol-forming substrate is supplied to the heating element than when it is not, for example, when the cartridge is depleted. Therefore, the rate of cooling of the heating element may provide an indication of whether the heating element is being supplied with liquid aerosol-forming substrate.

Alternatively, the step of determining whether the heating element is supplied with liquid aerosol-forming substrate may comprise providing a power pulse to the heating element and determining an electrical characteristic of the heating element. As used herein, the term “power pulse” refers to a full power pulse which is sufficient to start heating the heating element so that an electrical characteristic of the heating element can be determined as the heating element starts to heat. As its name suggests, a power pulse is applied to the heating element as a pulse of predetermined length, which will be considerably short than the time period power is applied to the heating element to heat the heating element during normal operation.

A power pulse may have any suitable duration. Where two or more power pulses are supplied to the heating element, each power pulse may have a substantially similar duration. The duration of each power pulse may be substantially equal to a power pulse duration. The power pulse duration may be stored in a memory. The power pulse duration may be between about 100 milliseconds and about 1 second or between about 200 milliseconds and about 500 milliseconds. The probing pulse duration may be about 300 milliseconds.

The electrical characteristic determined during the application of a power pulse may be a resistance of the heating element after a predetermined elapsed time. If the heating element is not being supplied with liquid aerosol-forming substrate, then its rate of cooling will be less than if it is being supplied with liquid aerosol-forming substrate. Accordingly, the resistance of the heating element will be higher after a predetermined elapsed time if the heating element is dry compared to if it is wet.

The electrical characteristic determined during the application of a power pulse may be a rate of change of the resistance of the heating element at a predetermined time. As mentioned above, if the heating element is not being supplied with liquid aerosol-forming substrate, then its rate of cooling will be less than if it is being supplied with liquid aerosol-forming substrate. Accordingly, a rate of change of the resistance of the heating element at a predetermined time may provide an indication of whether the heating element is wet or dry.

The electrical characteristic determined during the application of a power pulse may be a resistance of the heating element once a predetermined rate of change of the resistance has been reached. If the power pulse is sufficiently long in duration, the temperature of the heating element will stabilise at a certain temperature due to heat loss either to the surroundings in the case of a dry mesh or to an aerosol in the case of a wet mesh. When the temperature stabilises the rate of change of resistance will approach zero. This will occur at a higher temperature and hence a higher resistance in the case of a dry mesh and therefore this characteristic may provide an indication of whether the heating element is wet or dry.

The electrical characteristic used to determined whether the heating element is supplied with liquid aerosol-forming substrate may be selected from one or more of the foregoing. Values for one or more of the above electrical characteristics may be stored in a memory of an aerosol-generating system. By comparing the electrical characteristic to one or more values stored in the memory, an aerosol-generating system may determine whether the heating element is being supplied with liquid aerosol-forming substrate.

According to an example of the present disclosure, there is provided an aerosol-generating system. The aerosol-generating system may comprise an aerosol-generating device. The aerosol-generating system may comprise a cartridge. The cartridge may comprise a liquid storage portion for holding a liquid aerosol-forming substrate. The cartridge may comprise a heating element for heating the liquid aerosol-forming substrate. The cartridge may be configured to supply liquid aerosol-forming substrate to the heating element. The cartridge may be configured to be removably couplable to the aerosol-generating device. The aerosol-generating device may comprises a power supply for supplying electrical power to the heating element. The aerosol-generating device may comprise control circuitry for controlling the supply of power to the heating element. The control circuitry may be configured to provide a supply of power to the heating element. The control circuitry may be configured to monitor an electrical parameter indicating a temperature of the heating element. The control circuitry may be configured to determine whether the electrical parameter is greater than a maximum threshold value indicating that a threshold temperature of the heating element has been exceeded. The control circuitry may be configured to determine whether the electrical parameter is less than a minimum threshold value indicating that a threshold temperature of the heating element has been exceeded. The control circuitry may be configured to interrupt the supply of power to the heating element when the threshold temperature is exceeded. The control circuitry may be configured to allow the heating element to cool to a temperature at which the electrical parameter is below the maximum threshold value. The control circuitry may be configured to allow the heating element to cool to a temperature at which the electrical parameter is above the minimum threshold value. Following cooling, the control circuitry may be configured to determine whether the heating element is supplied with the liquid aerosol-forming substrate. The control circuitry may be configured to disable the power supply if the heating element is not supplied with the liquid aerosol-forming substrate.

According to an example of the present disclosure, there is provided an aerosol-generating system comprising an aerosol-generating device and a cartridge comprising a liquid storage portion for holding a liquid aerosol-forming substrate and a heating element for heating the liquid aerosol-forming substrate. The cartridge is configured to supply liquid aerosol-forming substrate to the heating element and to be removably couplable to the aerosol-generating device. The aerosol-generating device comprises a power supply for supplying electrical power to the heating element and control circuitry for controlling the supply of power to the heating element. The control circuitry is configured to: provide a supply of power to the heating element; monitor an electrical parameter indicating a temperature of the heating element; determine whether the electrical parameter is greater than a maximum threshold value or less than a minimum threshold value indicating that a threshold temperature of the heating element has been exceeded; interrupt the supply of power to the heating element when the threshold temperature is exceeded to allow the heating element to cool to a temperature at which the electrical parameter is below the maximum threshold value or above the minimum threshold value; following cooling, determine whether the heating element is supplied with the liquid aerosol-forming substrate; and disable the power supply if the heating element is not supplied with the liquid aerosol-forming substrate.

The aerosol-generating device may be configured to disable the power supply until the cartridge is replaced or the liquid aerosol-forming substrate in the liquid storage portion is replenished. This prevents the device from being used when there is insufficient liquid aerosol-forming substrate and reduces the likelihood of unwanted by-products being generated.

The aerosol-generating system may be a resistively heated aerosol-generating system. The control circuitry may be configured to monitor an electrical resistance of the heating element. The control circuitry may be configured to determine whether the electrical resistance is greater than a maximum threshold value indicating that a threshold temperature of the heating element has been exceeded.

Monitoring an electrical parameter of the heating element may comprise monitoring an electrical conductance of the heating element. The control circuitry may be configured to determine whether the electrical conductance is less than a minimum threshold value indicating that a threshold temperature of the heating element has been exceeded.

The heating element may comprise an electrically resistive heating element. The heating element may be made from any suitable electrically conductive material. Suitable materials include but are not limited to: semiconductors such as doped ceramics, electrically “conductive” ceramics (such as, for example, molybdenum disilicide), carbon, graphite, metals, metal alloys and composite materials made of a ceramic material and a metallic material. Such composite materials may comprise doped or undoped ceramics. Examples of suitable doped ceramics include doped silicon carbides. Examples of suitable metals include titanium, zirconium, tantalum and metals from the platinum group. Examples of suitable metal alloys include stainless steel, constantan, nickel-, cobalt-, chromium-, aluminum-, titanium-, zirconium-, hafnium-, niobium-, molybdenum-, tantalum-, tungsten-, tin-, gallium-, manganese- and iron-containing alloys, and super-alloys based on nickel, iron, cobalt, stainless steel, Timetal®, iron-aluminum based alloys and iron-manganese-aluminum based alloys. Timetal® is a registered trade mark of Titanium Metals Corporation. The heating element may be made from stainless steel, for example, a 300 series stainless steel such as AISI 304, 316, 304L, 316L.

Additionally, the heating element may comprise combinations of the above materials. A combination of materials may be used to improve the control of the resistance of the heating element. For example, materials with a high intrinsic resistance may be combined with materials with a low intrinsic resistance. This may be advantageous if one of the materials is more beneficial from other perspectives, for example price, machinability or other physical and chemical parameters. Advantageously, high resistivity heating allow more efficient use of battery energy.

The aerosol-generating system may be an inductively heated aerosol-generating system. The inductive aerosol-generating system may comprise an inductor. The heating element may comprise a susceptor. The inductor may be configured to generate an alternating magnetic field for heating the susceptor to generate an aerosol from the liquid aerosol-forming substrate supplied to the susceptor. The susceptor may be arranged to be heated by the inductor.

As used herein, a “susceptor” means an element that is heatable by penetration with an alternating magnetic field. A susceptor is typically heatable by at least one of Joule heating, through induction of eddy currents in the susceptor, and hysteresis losses.

In an inductive aerosol-generating system, monitoring an electrical resistance of the heating element may comprise monitoring an equivalent resistance of the inductor. As used herein when referring to the inductor, the term “equivalent resistance” means the resistance of the inductor as “seen” by an electric circuit during operation of the inductor. The equivalent resistance comprises the resistive losses in the windings of the inductor in series with the apparent resistance of the susceptor. Accordingly, the equivalent series resistance of the inductor is equal to the sum of the resistive losses in the windings of the inductor and the apparent resistance of the susceptor. The resistive losses in the windings of the coil, particularly at the frequency of operation of the inductor, are mainly due to skin effect losses in the winding of the inductor. The apparent resistance of the susceptor is the additional resistance seen by the electric circuit when the susceptor is inductively coupled to the inductor and is mainly due to eddy current and hysteresis losses in the susceptor. In a circuit diagram, the equivalent resistance is depicted as a resistance in series with the inductor. The equivalent resistance of the inductor also has a positive relationship with temperature, that is, as the temperature of the susceptor increases, the equivalent resistance of the susceptor also increases.

Monitoring an electrical parameter of the heating element may comprise monitoring an equivalent conductance of the inductor. The equivalent conductance is simply the reciprocal of equivalent resistance. The control circuitry may be configured to determine whether the equivalent conductance is less than a minimum threshold value indicating that a threshold temperature of the heating element has been exceeded.

The susceptor may be made from any suitable conductive material. Suitable materials include, but are not limited to, graphite, molybdenum, silicon carbide, stainless steels, niobium and aluminium. The susceptor may be a ferrite element. The material and the geometry for the susceptor may be chosen to provide a desired electrical resistance and heat generation.

The susceptor may comprise a magnetic material heatable by penetration with an alternating magnetic field. The term “magnetic material” is used herein to describe a material which is able to interact with a magnetic field, including both paramagnetic and ferromagnetic materials. The magnetic material may be any suitable magnetic material that is heatable by penetration with an alternating magnetic field. In some preferred embodiments, the magnetic material comprises a ferritic stainless steel. Suitable ferritic stainless steels include SAE 400 series stainless steels, such as SAE type 409, 410, 420 and 430 stainless steels.

The heating element may have any suitable form. The heating element may comprise, for example, a mesh, flat spiral coil, fibres or a fabric. The heating element may be fluid permeable.

In some preferred examples, the heating element is planar. The planar heating element may extend substantially in a plane.

In some preferred examples, the heating element comprises a mesh. The heating element may comprise an array of filaments forming a mesh. As used herein the term “mesh” encompasses grids and arrays of filaments having spaces therebetween. The term mesh also includes woven and non-woven fabrics.

The filaments may define interstices between the filaments and the interstices may have a width of between 10 micrometres and 100 micrometres. Preferably the filaments give rise to capillary action in the interstices, so that in use, the source liquid is drawn into the interstices, increasing the contact area between the heating element and the liquid.

The filaments may form a mesh of size between 160 and 600 Mesh US (+/−10%) (i.e. between 160 and 600 filaments per inch (+/−10%)). The width of the interstices may be between 35 micrometres and 140 micrometres, or between 25 micrometres and 75 micrometres. For example, the width of the interstices may be 40 micrometres, or 63 micrometres. The percentage of open area of the mesh, which is the ratio of the area of the interstices to the total area of the mesh is preferably between 25 and 56%. The mesh may be formed using different types of weave or lattice structures. Alternatively, the filaments consist of an array of filaments arranged parallel to one another.

The filaments may be formed by etching a sheet material, such as a foil. This may be particularly advantageous when the heater assembly comprises an array of parallel filaments. If the heating element comprises a mesh or fabric of filaments, the filaments may be individually formed and knitted together.

Preferably, the mesh is sintered. The filaments of the mesh may be sintered together. Advantageously, sintering the mesh creates electrical bonds between filaments extending in different directions. In particular, where the mesh comprises one or more of woven and non-woven fabrics, it is advantageous for the mesh to be sintered to create electrical bonds between overlapping filaments.

The mesh may also be characterised by its ability to retain liquid, as is well understood in the art.

The filaments of the mesh may have a diameter of between 8 micrometres and 100 micrometres, between 30 micrometres and 100 micrometres, between 8 micrometres and 50 micrometres, or between 8 micrometres and 39 micrometres. The filaments of the mesh may have a diameter of 50 micrometres. The filaments of the mesh may have any suitable cross-section. For example, the filaments may have a round cross section or may have a flattened cross-section.

Advantageously, the mesh heating element may have a relative permeability between 1 and 40000. In inductively heated systems, when a reliance on eddy currents for a majority of the heating is desirable, a lower permeability material may be used, and when hysteresis effects are desired then a higher permeability material may be used. Preferably, the material has a relative permeability between 500 and 40000. This may provide for efficient heating of the mesh susceptor.

In some examples, the cartridge comprises a heater assembly. The heater assembly comprises the heating element. The heater assembly may further comprise a liquid transfer element. The liquid transfer element may be in fluid communication with the heating element. The liquid transfer element may be in fluid communication with the liquid storage portion. The liquid transfer element may be arranged to convey liquid aerosol-forming substrate from the liquid storage portion to the heating element. In particular, the liquid transfer element may be arranged to convey liquid aerosol-forming substrate from the liquid storage portion across a major surface of the heating element. The heating element may be fixed to the liquid transfer element. The heating element may be integral with the liquid transfer element. The provision of a liquid transfer element may improve the wetting of the heating element, and so increase aerosol generation by the system.

In some preferred examples, the liquid transfer element is a wicking element. A wicking element may allow the heating element to be made from materials that do not themselves provide good wicking or wetting performance.

The heater assembly may comprise a plurality of heating elements. Where the heater assembly comprises a plurality of heating elements and a liquid transfer element, each heating element may be arranged in fluid communication with the liquid transfer element. The heater assembly may comprise a plurality of heating elements, and a plurality of wicking elements.

In some preferred examples, the heater assembly comprises a first heating element, and a second heating element, the second heating element being spaced apart from the first heating element. A wicking element may be arranged in the space between the first heating element and the second heating element. In some particularly preferred embodiments, the first heating element, second heating element, and wicking element are substantially planar, and the first heating element is arranged at a first side of the planar wicking element, and the second heating element is arranged at a second side of the planar wicking element, opposite the first side.

The heater assembly may comprises a heating region and at least one mounting region. The heating region is a region of the heater assembly is a region that is configured to be heated to a temperature required to vaporise the aerosol-forming substrate upon penetration by a suitable alternating magnetic field. The at least one mounting region of the heater assembly is a region that is configured to contact a housing or a heating element holder of the cartridge. In some preferred embodiments, the at least one mounting region extends into the liquid reservoir.

In an inductively heated aerosol-generating system, the heater assembly may comprise a susceptor assembly and the heating element or elements may be replaced with susceptors.

Where the liquid transfer assembly comprises a wicking element, the wicking element may comprise a capillary material. A capillary material is a material that is capable of transport of liquid from one end of the material to another by means of capillary action. The capillary material may have a fibrous or spongy structure. The capillary material preferably comprises a bundle of capillaries. For example, the capillary material may comprise a plurality of fibres or threads or other fine bore tubes. The fibres or threads may be generally aligned to convey liquid aerosol-forming substrate towards the heating element. In some embodiments, the capillary material may comprise sponge-like or foam-like material. The structure of the capillary material may form a plurality of small bores or tubes, through which the liquid aerosol-forming substrate can be transported by capillary action. Where the susceptor element comprises interstices or apertures, the capillary material may extend into interstices or apertures in the susceptor element. The susceptor element may draw liquid aerosol-forming substrate into the interstices or apertures by capillary action.

The wicking element may comprise an electrically insulative material. The wicking element may comprise a thermally insulative material. The wicking element may comprise a hydrophilic material. The wicking element may comprise an oleophilic material. Advantageously, forming the wicking element from a hydrophilic or an oleophilic material may encourage the transport of the aerosol-forming substrate through the wicking element.

The wicking element may comprise a non-metallic material. Examples of suitable materials for the wicking element are sponge or foam materials, ceramic- or graphite-based materials in the form of fibres or sintered powders, foamed metal or plastics materials, fibrous materials, for example made of spun or extruded fibres, such as cellulose acetate, polyester, or bonded polyolefin, polyethylene, terylene or polypropylene fibres, nylon fibres or ceramic fibres or glass fibres. Suitable materials for the wicking element may comprise cellulosic materials, such as cotton or rayon. Preferably, the wicking element may comprise rayon. The wicking element may consist of rayon. Wicking elements comprising porous ceramic materials may be particularly advantageous when one or both of the heating elements comprise an electrically conductive material deposited on the wicking element. A wicking element comprising a porous ceramic material may be an advantageous substrate for the manufacturing processes associated with the deposition of the electrically conductive material.

In some examples, the heating element or elements may be a part of the aerosol-generating device rather than the cartridge. In such examples, the cartridge may be configured to convey aerosol-forming substrate to the heating element or elements in the device, for example, using a liquid transfer element.

The cartridge may comprise a liquid storage portion or reservoir for holding a liquid aerosol-forming substrate. As used herein, the term “aerosol-forming substrate” refers to a substrate capable of releasing volatile compounds that can form an aerosol. Volatile compounds may be released by heating the liquid aerosol-forming substrate.

The aerosol-forming substrate may be liquid at room temperature. The aerosol-forming substrate may comprise both liquid and solid components. The liquid aerosol-forming substrate may comprise nicotine. The nicotine containing liquid aerosol-forming substrate may be a nicotine salt matrix. The liquid aerosol-forming substrate may comprise plant-based material. The liquid aerosol-forming substrate may comprise tobacco. The liquid aerosol-forming substrate may comprise a tobacco-containing material containing volatile tobacco flavour compounds, which are released from the aerosol-forming substrate upon heating. The liquid aerosol-forming substrate may comprise homogenised tobacco material. The liquid aerosol-forming substrate may comprise a non-tobacco-containing material. The liquid aerosol-forming substrate may comprise homogenised plant-based material.

The liquid aerosol-forming substrate may comprise one or more aerosol-formers. An aerosol-former is any suitable known compound or mixture of compounds that, in use, facilitates formation of a dense and stable aerosol and that is substantially resistant to thermal degradation at the temperature of operation of the system. Examples of suitable aerosol formers include glycerine and propylene glycol. Suitable aerosol-formers are well known in the art and include, but are not limited to: polyhydric alcohols, such as triethylene glycol, 1,3-butanediol and glycerine; esters of polyhydric alcohols, such as glycerol mono-, di- or triacetate; and aliphatic esters of mono-, di- or polycarboxylic acids, such as dimethyl dodecanedioate and dimethyl tetradecanedioate. The liquid aerosol-forming substrate may comprise water, solvents, ethanol, plant extracts and natural or artificial flavours.

The liquid aerosol-forming substrate may comprise nicotine and at least one aerosol-former. The aerosol-former may be glycerine or propylene glycol. The aerosol former may comprise both glycerine and propylene glycol. The liquid aerosol-forming substrate may have a nicotine concentration of between about 0.5% and about 10%, for example about 2%.

The cartridge may have a mouth end through which generated aerosol may be drawn by a user. The cartridge may have a connection end configured to couple the cartridge to an aerosol-generating device.

The cartridge may define an air inlet. The air inlet may be arranged at or around the connection end of the cartridge. The cartridge may define a mouth end opening. A user may be able to draw aerosol generated from the cartridge through the mouth end opening. The cartridge may define an enclosed airflow passage from the air inlet to the air outlet. The enclosed airflow passage may extend from the air inlet, past the susceptor element, to the mouth end opening.

The enclosed airflow passage may pass through the liquid reservoir. For example, the liquid reservoir may have an annular cross-section defining an internal passage, and the airflow passage may extend through the internal passage of the liquid reservoir.

The cartridge may comprise an outer housing. The outer housing may be formed from a durable material. The outer housing may be formed from a liquid impermeable material. The outer housing may be formed form a mouldable plastics material, such as polypropylene (PP) or polyethylene terephthalate (PET). The outer housing of the cartridge may define a portion of the liquid storage portion or reservoir. The outer housing may define the liquid storage portion. The outer housing and the liquid storage portion may be integrally formed. Alternatively, the liquid storage portion may be formed separately from the outer housing and arranged in the outer housing.

The aerosol-generating device may comprise a housing. The housing may be elongate. The housing may comprise any suitable material or combination of materials. Examples of suitable materials include metals, alloys, plastics or composite materials containing one or more of those materials, or thermoplastics that are suitable for food or pharmaceutical applications, for example polypropylene, polyetheretherketone (PEEK) and polyethylene. The material is preferably light and non-brittle.

The aerosol-generating device housing may define a cavity for receiving a portion of a cartridge. The aerosol-generating device may comprise one or more air inlets. The one or more air inlets may enable ambient air to be drawn into the cavity.

The aerosol-generating device may have a connection end configured to connect the aerosol-generating device to a cartridge. The connection end may comprise the cavity for receiving the cartridge.

The aerosol-generating device may have a distal end, opposite the connection end. The distal end may comprise an electrical connector configured to connect the aerosol-generating device to an electrical connector of an external power supply, for charging the power supply of the aerosol-generating device.

In inductively heated aerosol-generating systems, the inductor may have any suitable form. The inductor may be an inductor coil. The inductor coil may be a tubular coil, a helical coil or a planar or flat coil. The aerosol-generating system may further comprise at least one flux concentrator arranged to contain the alternating magnetic field generated by the inductor.

The aerosol-generating system may comprise any suitable number of inductors. The aerosol-generating system may comprise a single inductor. The aerosol-generating system may comprise a plurality of inductors. The aerosol-generating system may comprise one, two, three, four, five, six, seven, or eight inductors.

The inductor coil may be arranged at or around the cavity for receiving the cartridge. Preferably, the inductor coil is arranged to generate the alternating magnetic field in the cavity. The inductor coil may at least partially circumscribe the cavity.

The power supply may be any suitable power supply. Preferably, the power supply is a DC power supply. The power supply may be a battery. The battery may be a Lithium based battery, for example a Lithium-Cobalt, a Lithium-Iron-Phosphate, a Lithium Titanate or a Lithium-Polymer battery. The battery may be a Nickel-metal hydride battery or a Nickel cadmium battery. The power supply may be another form of charge storage device such as a capacitor. The power supply may be rechargeable and be configured for many cycles of charge and discharge. The power supply may have a capacity that allows for the storage of enough energy for one or more user experiences of the aerosol-generating system; for example, the power supply may have sufficient capacity to allow for the continuous generation of aerosol for a period of around six minutes, corresponding to the typical time taken to smoke a conventional cigarette, or for a period that is a multiple of six minutes. In another example, the power supply may have sufficient capacity to allow for a predetermined number of puffs or discrete activations of the aerosol-generating system.

The control circuitry may comprise any suitable controller or electrical components. The controller may comprise a memory. Information for performing the above-described method may be stored in the memory. The control circuitry may comprise a microprocessor. The microprocessor may be a programmable microprocessor, a microcontroller, or an application specific integrated chip (ASIC) or other electronic circuitry capable of providing control. The control circuitry may be configured to supply power to the heating element continuously following activation of the device, or may be configured to supply power intermittently, such as on a puff-by-puff basis. The power may be supplied to the heating element in the form of pulses of electrical current, for example, by means of pulse width modulation (PWM).

In inductively heated aerosol-generating systems, the control circuitry may be configured to supply an alternating current to the inductor. As used herein, an “alternating current” means a current that periodically reverses direction. The alternating current may have any suitable frequency. Suitable frequencies for the alternating current may be between 100 kilohertz (kHz) and 30 megahertz (MHZ). Where the inductor is a helical inductor coil, or a tubular inductor coil, the alternating current may have a frequency of between 500 kilohertz (kHz) and 30 megahertz (MHZ). Where the inductor is a flat inductor coil, the alternating current may have a frequency of between 100 kilohertz (kHz), and 1 megahertz (MHz).

Driving an alternating current through the inductor causes the inductor to generate an alternating magnetic field. The alternating magnetic field may have any suitable frequency for heating a heating portion of a susceptor element located in the alternating magnetic field. Suitable frequencies for the alternating magnetic field may be between 100 kilohertz (kHz) and 30 megahertz (MHz).

The control circuitry may comprise further electronic components. For example, in some embodiments, the control circuitry may comprise any of: sensors, switches, display elements.

In inductively heated aerosol-generating system having a DC power supply, the control circuitry may further comprise a DC/AC converter. The DC/AC converter may be arranged between the DC power supply and the inductor. The DC/AC converter may comprise a capacitor. The DC/AC converter may comprise an LC (inductor capacitor) load network. In a preferred example, the LC load network comprises the inductor used for heating the susceptor and a capacitor. The inductor may be connected in series with the capacitor. In some examples, the inductor may be powered by a Class-E power amplifier or a Class-D power amplifier.

The aerosol-generating system may comprise a puff detector. The puff detector may be configured to detect when a user draws on the aerosol-generating system. The puff detector may be any suitable sensor that is capable of detecting when a user draws on the aerosol-generating device. For example, the puff detector may be an airflow sensor. The control circuitry may be configured to supply power to the heating element when the puff detector detects a user drawing on the aerosol-generating system.

Features described in relation to one of the above examples may equally be applied to other examples of the present disclosure.

The invention is defined in the claims. However, below there is provided a non-exhaustive list of non-limiting examples. Any one or more of the features of these examples may be combined with any one or more features of another example, embodiment, or aspect described herein.

Example Ex1: A method of controlling heating in an aerosol-generating system comprising a heating element for heating a liquid aerosol-forming substrate supplied to the heating element, the method comprising: providing a supply of power to the heating element; monitoring an electrical parameter indicating a temperature of the heating element; determining whether the electrical parameter is greater than a maximum threshold value or less than a minimum threshold value indicating that a threshold temperature of the heating element has been exceeded; determining whether the heating element is supplied with the liquid aerosol-forming substrate if the temperature of the heating element does not exceed the threshold temperature; disabling the supply of power if the heating element is not supplied with the liquid aerosol-forming substrate.

Example Ex2: A method according to Example Ex1, further comprising interrupting the supply of power to the heating element when the threshold temperature is exceeded to allow the heating element to cool to a temperature at which the electrical parameter is below the maximum threshold value or above the minimum threshold value.

Example Ex3: A method according to Example Ex2, wherein the step of determining whether the heating element is supplied with the liquid aerosol-forming substrate is performed following cooling.

Example Ex4: A method according to Example Ex2 or Ex3, wherein the heating element is allowed to cool to a predetermined temperature below the threshold temperature.

Example Ex5: A method according to any of Examples Ex2 to Ex4, wherein allowing the heating element to cool comprises interrupting the supply of power for a predetermined period of time.

Example Ex6: A method according to Example Ex5, wherein the supply of power is interrupted for a period of time between 1 and 20 seconds, preferably between 1 and 10 seconds and more preferably between 1 and 5 seconds.

Example Ex7: A method according to any of Examples Ex1 to Ex6, further comprising determining an initial value of the electrical parameter and wherein the step of determining whether the electrical parameter is greater than a maximum threshold value or less than a minimum threshold value comprises determining whether a ratio between the initial value and a change in the in value of the monitored electrical parameter is greater than a maximum threshold value or less than a minimum threshold value.

Example Ex8: A method according to any of Examples Ex1 to Ex7, further comprising resuming the supply of power if the heating element is supplied with the liquid aerosol-forming substrate.

Example Ex9: A method according to any of Examples Ex1 to Ex8, further comprising the step of detecting a user puff before providing a supply of power to the heating element.

Example Ex10: A method according to any of Examples Ex1 to Ex9, wherein monitoring the electrical parameter comprises monitoring an electrical resistance of the heating element, and the method comprises determining whether the electrical resistance is greater than a maximum threshold value indicating that a threshold temperature of the heating element has been exceeded.

Example Ex11: A method according to Example Ex10, wherein the aerosol-generating system is an inductive aerosol-generating system comprising an inductor and the heating element is a susceptor arranged to be heated by the inductor, and wherein monitoring an electrical resistance of the heating element comprises monitoring an equivalent resistance of the inductor.

Example Ex12: A method according to any of Examples Ex1 to Ex11, further comprising the step of monitoring the cooling of the heating element.

Example Ex13: A method according to Example Ex12, wherein monitoring of the cooling of the heating element comprises providing a probing pulse to the heating element and determining an electrical resistance of the heating element during the probing pulse.

Example Ex14: A method according to Example Ex12 or Ex13, wherein monitoring of the cooling of the heating element comprises providing a plurality of probing pulses to the heating element and monitoring an electrical resistance of the heating element over successive probing pulses.

Example Ex15: A method according to any of Examples Ex1 to Ex14, wherein the step of determining whether the heating element is supplied with liquid aerosol-forming substrate comprises monitoring the rate of cooling of the heating element.

Example Ex16: A method according to any of Examples Ex1 to Ex14, wherein the step of determining whether the heating element is supplied with liquid aerosol-forming substrate comprises providing a power pulse to the heating element and determining an electrical characteristic of the heating element, the electrical characteristic being selected from one or more of the following: a resistance of the heating element after a predetermined elapsed time; a rate of change of the resistance of the heating element at a predetermined time; and a resistance of the heating element once a predetermined rate of change of the resistance has been reached.

Example Ex17: An aerosol-generating system comprising: an aerosol-generating device; and a cartridge comprising a liquid storage portion for holding a liquid aerosol-forming substrate and a heating element for heating the liquid aerosol-forming substrate; wherein the cartridge is configured to supply liquid aerosol-forming substrate to the heating element and to be removably couplable to the aerosol-generating device; wherein the aerosol-generating device comprises a power supply for supplying electrical power to the heating element and control circuitry for controlling the supply of power to the heating element; wherein the control circuitry is configured to: provide a supply of power to the heating element; monitor an electrical parameter indicating a temperature of the heating element; determine whether the electrical parameter is greater than a maximum threshold value or less than a minimum threshold value indicating that a threshold temperature of the heating element has been exceeded; determine whether the heating element is supplied with the liquid aerosol-forming substrate if the temperature of the heating element does not exceed the threshold temperature; disable the power supply if the heating element is not supplied with the liquid aerosol-forming substrate.

Example Ex18: An aerosol-generating system according to Example Ex17, wherein the control circuitry is further configured to interrupt the supply of power to the heating element when the threshold temperature is exceeded to allow the heating element to cool to a temperature at which the electrical parameter is below the maximum threshold value or above the minimum threshold value.

Example Ex19: An aerosol-generating system according to Example Ex18, wherein the control circuitry is configured to determine whether the heating element is supplied with the liquid aerosol-forming substrate following cooling.

Example Ex20: An aerosol-generating system according to Example Ex18 or Ex19, wherein the control circuitry is configured to allow the heating element to cool to a predetermined temperature below the threshold temperature.

Example Ex21: A method according to any of Examples Ex18 to Ex20, wherein allowing the heating element to cool comprises interrupting the supply of power for a predetermined period of time.

Example Ex22: A method according to Example Ex21, wherein the supply of power is interrupted for a period of time between 1 and 20 seconds, preferably between 1 and 10 seconds and more preferably between 1 and 5 seconds.

Example Ex23: An aerosol-generating system according to any of Examples Ex17 to Ex22, wherein monitoring the electrical parameter comprises monitoring an electrical resistance of the heating element and wherein the control circuitry is configured to determine whether the electrical resistance is greater than a maximum threshold value indicating that a threshold temperature of the heating element has been exceeded.

Example Ex24: An aerosol-generating system according to Example Ex23, wherein the aerosol-generating device is an inductive aerosol-generating device comprising an inductor and the heating element is a susceptor arranged in the cartridge to be heated by the inductor, and wherein monitoring the electrical resistance comprises monitoring an equivalent resistance of the inductor.

Example Ex25: An aerosol-generating system according to any of Examples Ex17 to Ex24, wherein the aerosol-generating device is configured to disable the power supply until the cartridge is replaced or the liquid aerosol-forming substrate in the liquid storage portion is replenished.

Example Ex26: An aerosol-generating system according to any of Examples Ex14 to Ex25, further comprising an indicator to indicate to a user that the cartridge needs to be replaced or the liquid aerosol-forming substrate in the liquid storage portion needs to be replenished.

Example Ex27: An aerosol-generating system according to any of Examples Ex14 to Ex26, wherein the electrical parameter is a resistance and the maximum threshold value of the resistance is at least 1.05 ohms, and optionally is between about 1.05 ohms and 2.20 ohms.

Example Ex28: An aerosol-generating system according to any of Examples Ex14 to Ex26, wherein the electrical parameter is an equivalent resistance and the maximum threshold value of the equivalent resistance is at least 0.3 ohms, and optionally is between about 0.3 ohms and 2.5 ohms.

Example Ex29: An aerosol-generating system according to any of Examples Ex14 to Ex26, wherein the electrical parameter is an electrical conductance and wherein the control circuitry is further configured to determine whether the electrical conductance is less than a minimum threshold value indicating that a threshold temperature of the heating element has been exceeded.

Example Ex30: An aerosol-generating system according to any of Examples Ex14 to Ex26, wherein the electrical parameter is an equivalent conductance and wherein the control circuitry is further configured to determine whether the equivalent conductance is less than a minimum threshold value indicating that a threshold temperature of the heating element has been exceeded.

Example Ex31: An aerosol-generating system according to any of Examples Ex14 to Ex30, wherein the heating element is a mesh.

Examples will now be further described with reference to the figures in which:

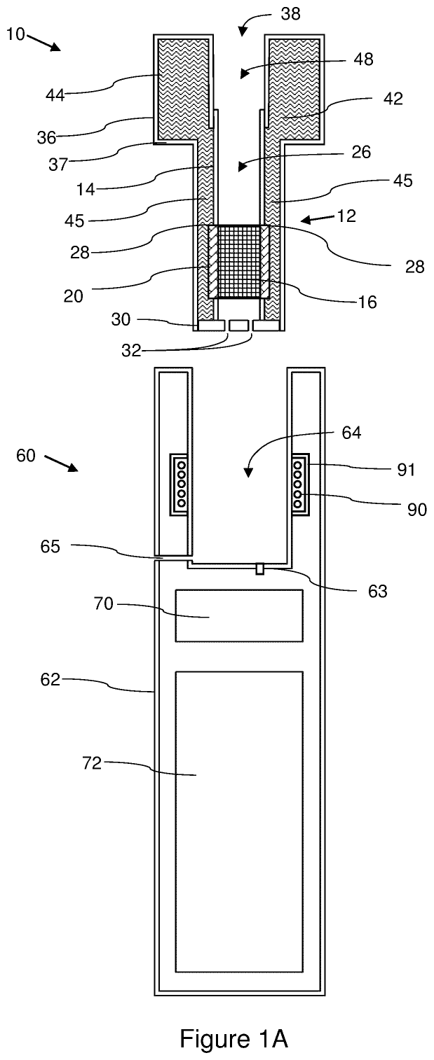

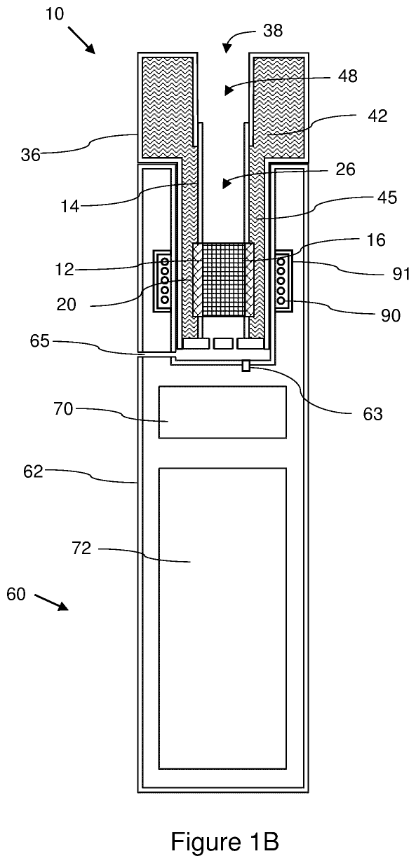

FIG. 1A is a schematic cross-sectional view of an inductively heated aerosol-generating system according to an example of the present disclosure, the aerosol-generating system comprising an aerosol-generating device and a cartridge and the cartridge being shown removed from the aerosol-generating device;

FIG. 1B is a schematic cross-sectional view of the aerosol-generating system of FIG. 1A showing the cartridge attached to the device;

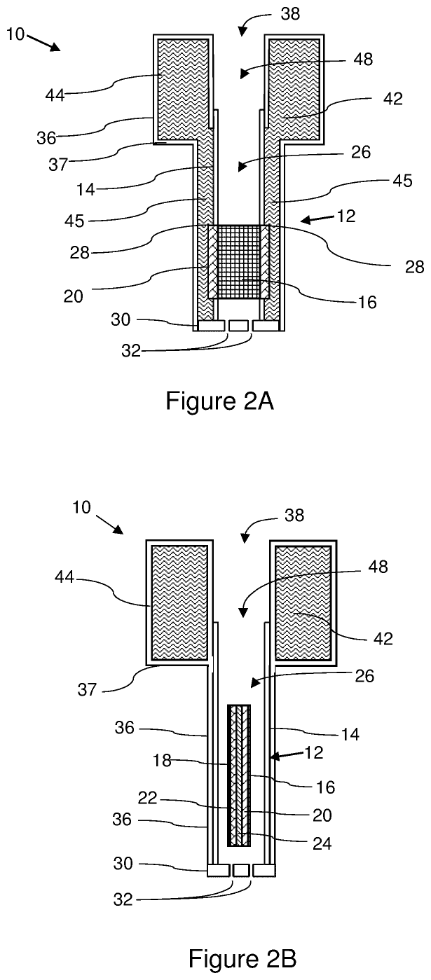

FIG. 2A is a schematic cross-sectional view of the cartridge of FIGS. 1A and 1B;

FIG. 2BA is a schematic cross-sectional view of the cartridge of FIG. 2A rotated by 90 degrees about a central longitudinal axis of the cartridge;

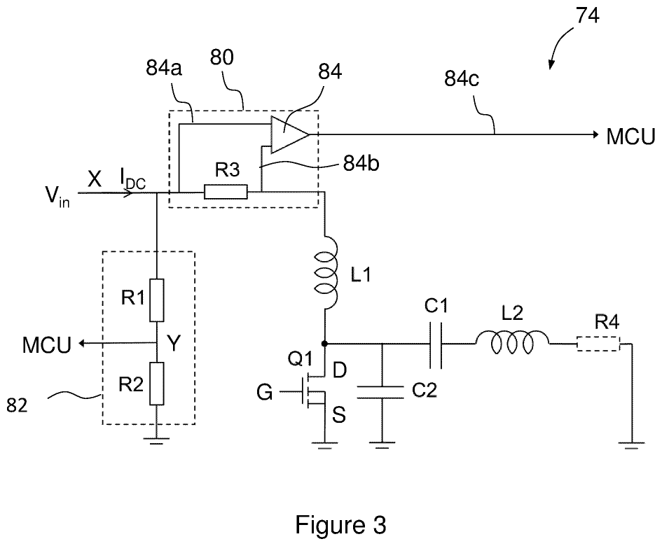

FIG. 3 is a schematic circuit diagram of part of the control circuitry for an inductively heated aerosol-generating system according to an example of the present disclosure;

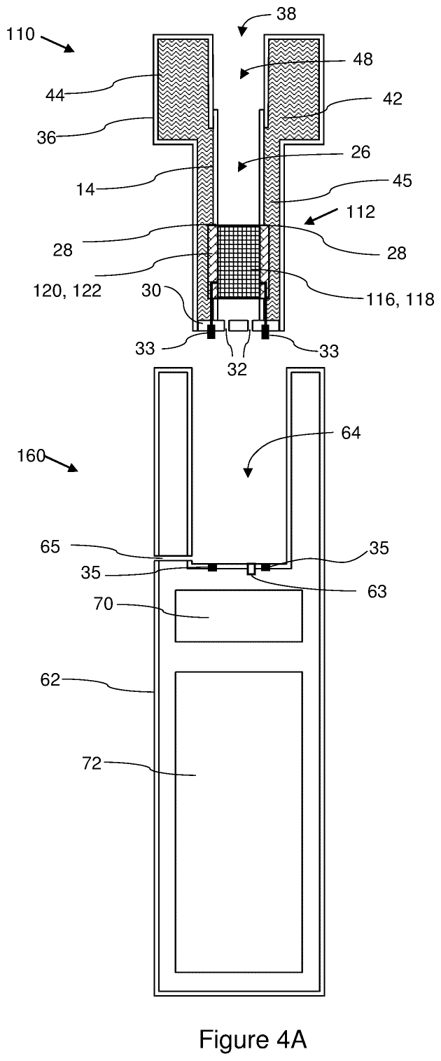

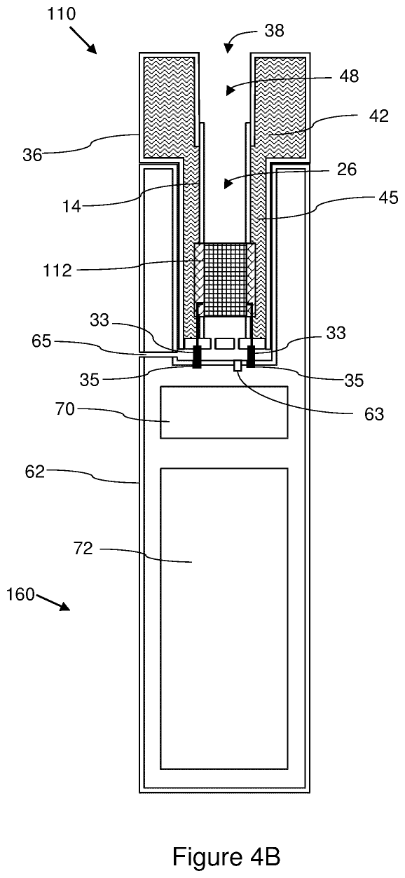

FIG. 4A is a schematic cross-sectional view of a resistively heated aerosol-generating system according to an example of the present disclosure, the aerosol-generating system comprising an aerosol-generating device and a cartridge and the cartridge being shown removed from the aerosol-generating device;

FIG. 4B is a schematic cross-sectional view of the aerosol-generating system of FIG. 4A showing the cartridge attached to the device;

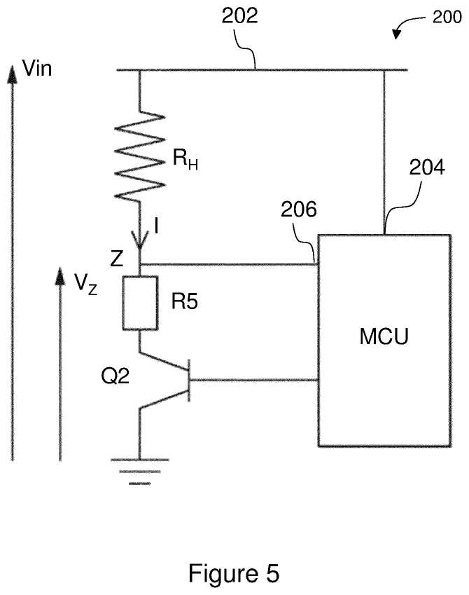

FIG. 5 is a schematic circuit diagram of part of the control circuitry for a resistively heated aerosol-generating system according to an example of the present disclosure;

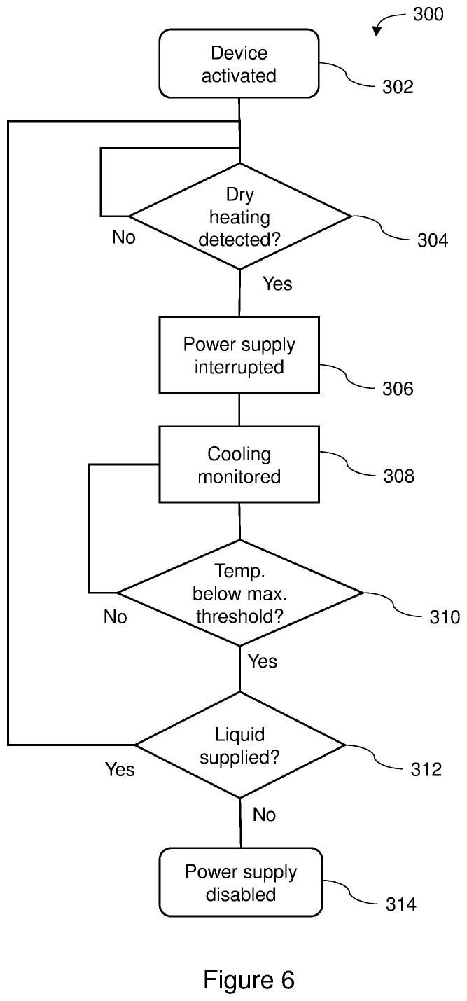

FIG. 6 is a flow diagram of a method for controlling an overheating or dry heating situation in an aerosol-generating system according to an example of the present disclosure;

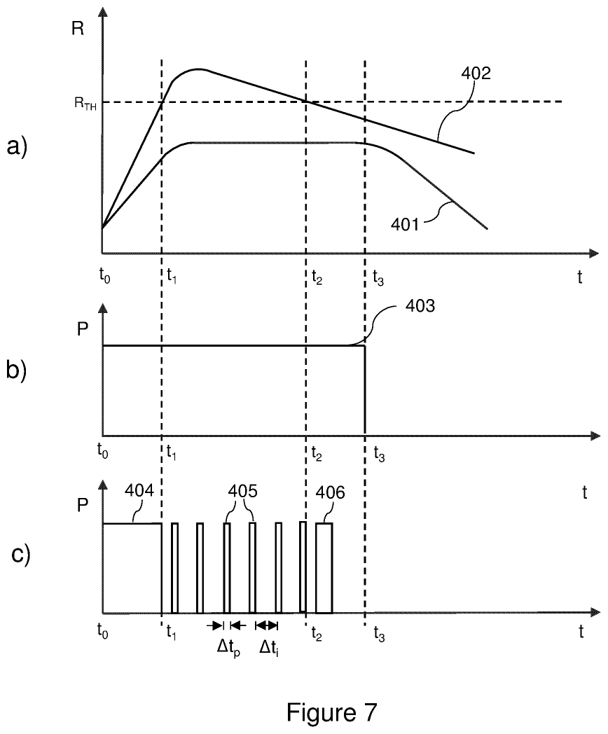

FIG. 7 shows three graphs a), b) and c): graph a) is a plot of resistance against time and shows the resistance profile for a normal heating cycle in which the heating element is supplied with liquid aerosol-forming substrate and the resistance profile for a dry heating situation; graph b) is a plot of power against time for a normal heating cycle; and graph c) is a plot of power against time for a dry heating situation; and

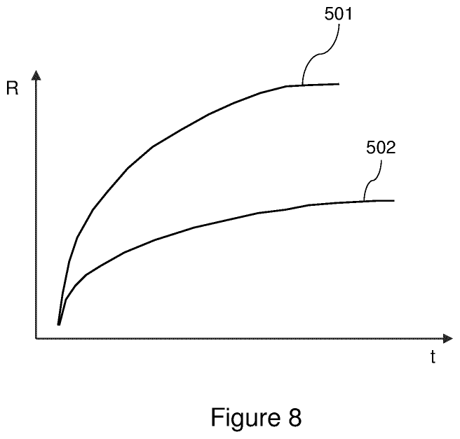

FIG. 8 is a graph of resistance against time showing the resistance profile for a wet and dry heating situation during a power pulse used to determine whether the heating element is supplied with liquid aerosol-forming substrate.

Referring to FIGS. 1A and 1B, there is shown a schematic illustration of an inductively heated aerosol-generating system according to an example of the present disclosure. The aerosol-generating system comprises a cartridge 10 and an aerosol-generating device 60. The cartridge 10 is configured to be received by the aerosol-generating device 60. In FIG. 1A the cartridge 10 is shown removed or separated from the aerosol-generating device 60. In FIG. 1B the cartridge 10 is shown received in and attached to the aerosol-generating device 60. The aerosol-generating system is portable and has a size comparable to a conventional cigar or cigarette.

FIGS. 2A and 2B show schematic illustrations of the cartridge 10 of FIGS. 1A and 1B. The cartridge 10 has a mouth end and a connection end, opposite the mouth end. The connection end is configured for connection of the cartridge 10 to an aerosol-generating device 60, as described in more detail below.

The cartridge 10 comprises an outer housing 36 formed from a mouldable plastics material, such as polypropylene. The outer housing 36 defines a mouth end opening 38 at the mouth end of the cartridge 10. The external width of the outer housing 36 is greater at the mouth end of the cartridge 10 than at the connection end. This forms a shoulder 37 between the mouth end and the connection end. This arrangement enables the connection end of the cartridge 10 to be received in a cavity 64 of the aerosol-generating device 60, with the shoulder 37 locating the cartridge 10 in the correct position in the device. This also enables the mouth end of the cartridge 10 to remain outside of the aerosol-generating device 60, with the mouth end conforming to the external shape of the aerosol-generating device 60.

The cartridge 10 further comprises a susceptor assembly 12 mounted in a susceptor holder 14. The susceptor assembly 12 is described in more detail below. The susceptor holder 14 comprises a tubular body formed from a mouldable plastic material, such as polypropylene. The tubular body of the susceptor holder 14 comprises a side wall defining an internal passage 26, having open ends and a central longitudinal axis. A pair of openings 28 extend through the side wall, at opposite sides of the tubular susceptor holder 14. The openings 28 are arranged centrally along the length of the susceptor holder 14. The susceptor holder 14 further comprises a base 30 that partially closes one end of the internal passage 26. The base 30 comprises a plurality of air inlets 32 that enable air to be drawn into the internal passage 26 through the partially closed end.

The cartridge 10 further comprises a liquid storage portion or liquid reservoir 44 for storing a liquid aerosol-forming substrate 42. The liquid reservoir 44 comprises an annular space defined by the outer housing 36 and an internal passage 48 that extends between the mouth end air outlet 38 and the open end of an internal passage 26 of a susceptor holder 14.

The cartridge 10 further comprises two channels 45 defined between an inner surface of the outer housing 36 and an outer surface of the susceptor holder 14. The two channels 45 extend from the liquid reservoir 44 at the mouth end of the cartridge 10 to the connection end of the cartridge 10.

The cartridge 10 comprises a susceptor assembly 12 mounted in the susceptor holder 14. The susceptor assembly 12 and the susceptor holder 14 are located towards the connection end of the cartridge 10. The susceptor assembly 12 is planar and thin, having a thickness dimension that is substantially smaller than a length dimension and a width dimension. The susceptor assembly 12 is shaped in the form of a rectangle.

The susceptor assembly 12 comprises a susceptor comprising a first susceptor element 16 and a second susceptor element 18 (see FIG. 2B). The first susceptor element 16 and a second susceptor element 18 act as heating elements for heating a liquid aerosol-forming substrate, as described further below. The susceptor assembly 12 also comprises a wicking element for transporting the liquid aerosol-forming substrate 42 from the liquid reservoir 44 to the susceptor. The wicking element comprises a first wicking layer 20 and a second wicking layer 22 (see FIG. 2B). The susceptor assembly 12 further comprises a spacer element 24 (see FIG. 2B) between the first wicking layer 20 and the second wicking layer 22.

Each of the first susceptor element 16, the second susceptor element 18, the first wicking layer 20 and the second wicking layer 22 generally form the shape of a rectangle. Each susceptor layer has the same length and width dimensions. The width of the susceptor elements 16, 18 is smaller than the width of the first wicking layer 20 and the second wicking layer 22. Therefore, each of the first wicking layer 20 and the second wicking layer 22 comprise outer, exposed portions of wicking element that protrude through the openings 28 in the side wall of the susceptor holder 14 and into the two channels 45. The first 16 and second 18 susceptor elements are substantially identical, and comprise a sintered mesh formed from stainless steel filaments which a suitable for being heated by an alternating magnetic field. The first wicking layer 20 and the second wicking layer 22 comprise a porous body of cotton filaments. The first wicking layer 20 and the second wicking layer 22 are configured to supply liquid aerosol-forming substrate 42 from the outer, exposed surfaces of the first wicking layer 20 and the second wicking layer 22 to the first 16 and second 18 susceptor elements.

The first 16 and second 18 susceptor elements are configured to be heated by penetration with an alternating magnetic field for vaporising the liquid aerosol-forming substrate 42. The first wicking layer 20 and the second wicking layer 22 contact the susceptor holder 14 in the openings 28, such that the susceptor holder 14 supports the susceptor assembly 12 in position in the cartridge 10.

The susceptor assembly 12 is partially arranged inside the internal passage 26 of the tubular susceptor holder 14, and extends in a plane parallel to a central longitudinal axis of the susceptor holder 14. The first 16 and second 18 susceptor elements are arranged entirely within the internal passage 26 of the susceptor holder 14.

The aerosol-generating device 60 comprises a substantially cylindrical housing 62 having a connection end and a distal end opposite the connection end. A cavity 64 for receiving the connection end of the cartridge 10 is located at the connection end of the device 60. An air inlet 65 is provided through the outer housing 62 at the base of the cavity 64 to enable ambient air to be drawn into the cavity 64 at the base. A puff detector in the form of an airflow sensor 63 is arranged in the base of the cavity 64 to detect when air is being drawn into the cavity 64.

The aerosol-generating device 60 comprises an inductive heating arrangement arranged within the device outer housing 62. The inductive heating arrangement includes an inductor coil 90, control circuitry 70 and a power supply 72. The power supply 72 comprises a rechargeable lithium iron phosphate battery, that is rechargeable via an electrical connector (not shown) at the distal end of the device 60. The control circuitry 70 is connected to the power supply 72, and to the inductor coil 90, such that the control circuitry 70 controls the supply of power to the inductor coil 90. The control circuitry 70 is configured to supply an alternating current to the inductor coil 90. The control circuitry 70 is also connected to the airflow sensor 63.

As can be seen in FIG. 1B, the inductor coil 90 is positioned around the susceptor assembly 12 when the cartridge 10 is received in the cavity 64. The inductor coil 90 has a size and a shape matching the size and shape of heating regions of the susceptor elements. The inductor coil 90 is made with a copper wire having a round circular section, and is arranged on a coil former element (not shown). The inductor coil 90 is a helical coil, and has a circular cross section when viewed parallel to the longitudinal axis of the aerosol-generating device 60.

The inductor coil 90 is configured such that when the alternating current is supplied to the inductor coil, the inductor coil generates an alternating magnetic field in the region of the susceptor assembly 12 when the cartridge 10 is received in the cavity 64.

The inductive heating arrangement further includes a flux concentrator element 91. The flux concentrator element 91 has a greater radius than the inductor coil 90, and so partially surrounds the inductor coil 90. The flux concentrator element 91 is configured to reduce the stray power losses from the generated magnetic field.

An advantage of the inductively heated aerosol-generating system of FIGS. 1A and 1B is that it allows for a wireless coupling between the induction coil 90 of the aerosol-generating device 160 and the susceptor assembly 12 arranged within the cartridge 10. The wireless coupling means that the liquid aerosol-forming substrate contained in the reservoir 44 can be kept perfectly sealed during storage, and also in operation, when the cartridge 10 is received in the aerosol-generating device 160.

In operation, when a user puffs on the mouth end air outlet 38 of the cartridge 10, ambient air is drawn into the base of the cavity 64 through system air inlet 65, and into the cartridge 10 through the air inlets 32 in the base 30 of the cartridge 10. The ambient air flows through the cartridge 10 from the base 30 to the mouth end air outlet 38, through the air passage, and over the susceptor assembly 12 and in particular over and across the first susceptor element 16 and the second susceptor element 18.

The airflow sensor 63 detects air which is drawn through the system by the user puffing on the mouth end air outlet 38. The airflow sensor 63 sends a signal to the control circuitry 70 to activate the system. The control circuit 70 then controls the supply of electricity from the power supply 72 to the inductor coil 90 when the system is activated.

When the system is activated, an alternating current is established in the inductor coil 90, which generates an alternating magnetic field in the cavity 64 that penetrates the susceptor assembly 12 causing the first susceptor element 16 and the second susceptor element 18 to heat. Liquid aerosol-forming substrate 42 in the two channels 45 is drawn into the susceptor assembly 12 through the first wicking layer 20 and the second wicking layer 22 to the first susceptor element 16 and the second susceptor element 18, respectively. Liquid aerosol-forming substrate 42 may also be transferred between the first wicking layer 20 and the second wicking layer 22, through the spacer element 24 (see FIG. 2B). The liquid aerosol-forming substrate 42 at the first susceptor element 16 and the second susceptor element 18 is heated, and volatile compounds from the heated liquid aerosol-forming substrate are released into the air passage of the cartridge 10, which cool to form an aerosol. The aerosol is entrained in the air being drawn through the air passage of the cartridge 10, and is drawn out of the cartridge 10 at the mouth end air outlet 38 for inhalation by the user.

FIG. 2A shows a schematic illustration of the cartridge 10 separately from the aerosol-generating device 60.

FIG. 2B shows a schematic illustration of the cartridge of FIG. 2A rotated by 90 degrees about a central longitudinal axis of the cartridge. The layered structure of the susceptor assembly 12 can be seen in FIG. 2B, in particular, the spacer element 24 positioned between and in contact with the first wicking layer 20 and the second wicking layer 22 can be seen. The spacer element 24 is fluid permeable and is configured to allow the liquid aerosol-forming substrate 42 to move between the first wicking layer 20 and the second wicking layer 22. The spacer element 24 generally forms the shape of a rectangle, and has the same length and width dimensions as the first wicking layer 20 and the second wicking layer 22. The spacer element 24 comprises a porous body of cotton. The first susceptor element 16 and the second susceptor element 18 are arranged at the outer major surfaces of the susceptor assembly 12.

FIG. 3 shows a schematic circuit diagram of part of the control circuitry 70 of the inductively heated aerosol-generating system of FIGS. 1A and 1B in more detail. The circuit 74 of FIG. 3 is used for driving the induction coil 90 of the aerosol-generating device 60 of FIGS. 1A and 1B and for determining one or more electrical parameters of a susceptor, that is, first susceptor element 16 and the second susceptor element 18 shown in the cartridge 10 of FIG. 2B. The circuit 74 has an input voltage Vin, which is received at a point X in FIG. 3. The circuit 74 comprises a transistor switch Q1 and a first inductor L1, which act as drive circuitry for driving the induction coil 90 and a DC/AC voltage converter. The transistor switch Q1 comprises a field effect transistor (FET), for example, a metal-oxide semiconductor field effect transistor (MOSFET) and the first inductor L1 comprises a radio frequency choke. The input voltage Vin is fed to transistor switch Q1 via resistor R3 (discussed in more detail below) and the first inductor L1. The first inductor L1 helps to reduce radio frequencies which may be present at the input X from entering the circuit. The gate G of the transistor switch Q1 receives a switching signal generated by another component (not shown) of the control circuitry to turn the transistor switch Q1 ON and OFF. The switching signal is a square wave having a substantially 50% duty cycle.

The circuit 74 further comprises a first capacitor C1 connected in series with a second inductor L2, which corresponds to the induction coil 90 of the aerosol-generating device 60 of FIGS. 1A and 1B. A second capacitor C2 is connected between the drain D of transistor switch Q1 and electrical ground, and acts as a shunt capacitor. The first capacitor C1, second inductor L2, and second capacitor C2 define a DC/AC voltage converter for converting the switching signal passed to the transistor switch Q1 into an AC voltage across an equivalent resistance R4. Equivalent resistance R4 is equivalent to the ohmic resistance Rcoil of the second inductor L2 connected in series with the apparent ohmic resistance Ra of the susceptor 16, 18. Resistance R4 is shown in dotted outline in FIG. 5 to indicate that it is an equivalent resistance of the second inductor L2 and the susceptor elements 16, 18, rather than an actual resistor in the circuit.

Together, the first inductor L1, transistor switch Q1, first capacitor C1, second inductor L2, and second capacitor C2 form a Class-E power amplifier. The general operating principle of the Class-E power amplifier is known and is described in detail in the article “Class-E RF Power Amplifiers”, Nathan 0. Sokal, published in the bimonthly magazine QEX, edition January/February 1001, pages 9-20, of the American Radio Relay League (ARRL), Newington, CT, U.S.A. and therefore, will not be discussed further here.

It has been found that using a Class-E amplifier to power the second inductor L2 is highly efficient. This is because, due to the configuration of the circuit, current flow through transistor switch Q1 does not occur at the same time as there is voltage across the transistor switch Q1. Accordingly, substantially no energy is dissipated in transistor switch Q1, and instead substantially all the power is fed to the load equivalent resistance R4. Furthermore, the first capacitor C1 and second inductor L2 form a series resonant circuit, which is tuned to the switching frequency of the switching signal. The first capacitor C1 and second inductor L2 act as a bandpass filter which allows an AC voltage signal to be transferred to the load equivalent resistance R4 only at the desired operating frequency of the second inductor L2. This means that power is transferred to the load equivalent resistance R4 only at the switching frequency of the switching signal, and any harmonic frequencies are significantly suppressed, which helps to further improve efficiency.

In addition, the second inductor L2 and capacitors C1 and C2 form an LC load network, or matching network, which is configured to operate at low ohmic load, and helps to match the output impedance of the DC/AC converter to the load equivalent resistance R4. In particular, the capacitors C1 and C2 have been tuned to reduce the ohmic load of the second inductor L2 relative to the susceptor elements 16, 18 so that more heat is dissipated in the susceptor elements 16, 18 compared to the inductor L2, which is what is desired for heating the aerosol-forming substrate.

The circuit 74 comprises relatively few components compared to other driving and sensing circuits for aerosol-generating devices, and therefore the printed circuit board area required for mounting these components can be kept small, which helps to reduce the overall dimensions of the aerosol-generating device 60. Furthermore, by using the second inductor L2 in the DC/AC conversion, the number of components is further reduced.

During operation, the second inductor L2 generates an alternating magnetic field that induces eddy currents in the susceptor elements 16, 18 of the cartridge 10, heating the susceptor elements 16, 18. As the susceptor elements 16, 18 are heated during operation, liquid aerosol-forming substrate supplied to the susceptor elements 16, 18 from the liquid reservoir 44, via the first wicking layer 20 and the second wicking layer 22, is vaporised.

The inventors have recognised that while liquid aerosol-forming substrate is being supplied to the susceptor elements 16, 18, and the liquid aerosol-forming substrate is being vaporised, the temperature and apparent resistance Ra of the susceptor elements 16, 18 remains substantially constant. However, if the supply of liquid aerosol-forming substrate to the susceptor elements 16, 18 reduces, or stops, as the liquid reservoir 44 is depleted, the temperature and apparent resistance Ra of the susceptor elements 16, 18 increases, causing the equivalent resistance R4 to increase, and the DC current I_{DC} drawn by the heater module 74 at a constant voltage to decrease.

The circuit of FIG. 3 further comprises two sensor circuits for determining the equivalent resistance R4 (or a corresponding equivalent conductance G4), namely current sensor circuit 80 and voltage sensor circuit 82.

The current sensor circuit 80 comprises a current sensor in the form of resistor R3, which has a known value. The resistor R3 is connected in series between point X (which receives the input voltage Vin) and the first inductor L1. Therefore, during operation, the DC current I_{DC} passing through resistor R3 is substantially the same as the current being drawn by the circuit 74. Resistor R3 has an appropriately low resistance value to help to reduce resistive losses.

The current sensor circuit 80 further comprises a differential amplifier 84 having two inputs, 84a and 84b, which are connected at either side of the resistor R3, and therefore receive voltage signals from either side of the resistor R3. The differential amplifier 84 has an output, 84c, which outputs a voltage that is proportional to the difference between the voltages received at the inputs 84a and 84b, that is, a voltage drop V_{R3} across resistor R3. The output 84c of differential amplifier 84 is connected to an analogue-to-digital converter (ADC) input of a microcontroller MCU, which is also part of the control circuitry 70 of the aerosol-generating device 60 of FIGS. 1A and 1B. Therefore, based on the signal received from the output 84c of the differential amplifier 84, the microcontroller MCU is configured to determine the voltage drop V_{R3} across resistor R3. Since the resistor R3 has a known value, the DC current IDC through resistor R3 which is fed to the circuit 74 can be determined by the microcontroller MCU through application of Ohm's law, as shown in equation (1):

$${I}_{DC} = {V}_{R 3} / R 3 \qquad ( 1 )$$

The voltage sensor circuit 82 comprises a first resistor R1, and a second resistor R2 connected in series between point X in FIG. 3, where the input voltage Vin is received, and electrical ground. Resistors R1 and R2 form a voltage divider, or potential divider, and have equal resistance values so that the voltage at a point Y between resistors R1 and R2 is equal to half the input voltage Vin. Point Y is connected to an analogue-to-digital converter (ADC) input of the microcontroller MCU to provide a voltage signal corresponding to the voltage at point Y to the microcontroller MCU. This allows the microcontroller MCU to determine the input voltage Vin by multiplying the voltage signal received from point Y by two. The voltage sensor circuit 82 allows input voltage Vin to be determined where the input voltage may vary, for example, due to the use of different battery voltages, etc. It will be appreciated that other resistance values could be used for resistors R1 and R2 but that this would involve a corresponding adjustment to the voltage calculation performed by the microcontroller. Resistors R1 and R2 have relatively high resistance values to reduce current draw through the potential divider.

As mentioned above, a Class-E power amplifier has been found to be a highly efficient means for transferring power to the load equivalent resistance R4. Consequently, the DC current I_{DC} through resistor R3 is indicative of the current being supplied to the load equivalent resistance R4. Furthermore, the resistance value of resistor R3 is relatively small, and therefore the voltage drop across resistor R3 can be substantially ignored. Therefore, the value of the load equivalent resistance R4 can be determined by the microcontroller MCU by application of Ohm's law, as shown in equation (2):

$$R 4 = V in / {I}_{DC} \qquad ( 2 )$$

Equation (2) above can be rewritten as shown in equation (3) below to give the equivalent conductance G4 of the load equivalent resistance R4:

$$G 4 = {I}_{DC} / V in \qquad ( 3 )$$

The equivalent conductance G4 is the reciprocal of the equivalent resistance R4. An advantage of determining the equivalent conductance G4 in accordance with equation (3) is that conductance is indicative or directly related to the DC current I_{DC} when the voltage Vin is constant, which is generally the case for the majority of the discharge cycle of a battery or if a DC voltage regulator or converter is used to provide a constant voltage to the circuit 74. Therefore, the current being supplied to the circuit 74, and being measured by the current sensor circuit 80, provides a direct indication of the equivalent conductance G4 of the load equivalent resistance R4. As a result, the measured value of the DC current I_{DC} can be used by the microcontroller 70 as a proxy for the value of the equivalent conductance G4 without having to determine the equivalent conductance G4 or the equivalent resistance R4, thereby reducing and simplifying the calculations which need to be performed.

FIGS. 4A and 4B show a schematic illustration of a resistively heated aerosol-generating system according to an example of the present disclosure. The aerosol-generating system comprises a cartridge 110 and an aerosol-generating device 160. The cartridge 110 is configured to be received by the aerosol-generating device 160. In FIG. 4A the cartridge 110 is shown removed or separated from the aerosol-generating device 160. In FIG. 1B the cartridge 110 is shown received in and attached to the aerosol-generating device 160.

The resistively heated aerosol-generating system of FIGS. 4A and 4B is similar to the inductively heated aerosol-generating system of FIGS. 1A and 1B and like reference numerals have been used in FIGS. 4A and 4B to label like components. The main difference in the aerosol-generating system of FIGS. 4A and 4B is that it is configured to resistively heat a heating element in the cartridge 110 and therefore the aerosol-generating device 160 of FIGS. 4A and 4B does not have an induction coil.

Instead of a susceptor assembly, the cartridge 110 of FIGS. 4A and 4B comprises a heater assembly 112. However, the heater assembly 112 has substantially the same structure as the susceptor assembly 12 of FIGS. 1A and 1B. The heater assembly 112 comprises a first heating element a16 and a second heating element 118. The first heating element 116 and a second heating element 118 act are configured to heat a liquid aerosol-forming substrate. The heater assembly 112 also comprises a wicking element for transporting the liquid aerosol-forming substrate 42 from the liquid reservoir 44 to the first 116 and second 118 heating elements. The wicking element comprises a first wicking layer 120 and a second wicking layer 122. The heater assembly 12 further comprises a spacer element (not shown) between the first wicking layer 120 and the second wicking layer 122.

The first heating element 116, first wicking layer 120, spacer element, second wicking layer 122 and second heating element 118 of the heater assembly 112 of FIGS. 4A and 4B have the same shape, size and layered structure as the first susceptor element 16, first wicking layer 20, spacer element 24, second wicking layer 22 and second susceptor element 18 of the susceptor assembly 12 of FIGS. 1A, 1B, 2A and 2B. The only difference is that the first 116 and second 118 heating elements comprise a sintered mesh formed from stainless steel filaments which a suitable for being resistively heated.

The first 116 and second 118 heating elements are connected to cartridge electric contacts 33 located in the base 30 of the cartridge 110. The cartridge electric contacts protrude distally from the base 30 and are configured to make contact with corresponding device electric contacts 35 located in the base of the cavity 64 when the cartridge 110 is received in the cavity 64, as shown in FIG. 4B. An electrical contact between the aerosol-generating device 160 and the cartridge 110 is therefore established via contact between the cartridge electric contacts 33 and the device electric contacts 35 so that power can be supplied from the power supply 72 to the first 116 and second 118 heating elements.

In operation, the airflow sensor 63 detects a user puff on the mouth end opening 38 and the control circuitry 70 of the aerosol-generating device 160 activates the device causing an electrical current to flow from the power source 72 to the first 116 and second 118 heating elements to resistively heat a liquid aerosol-forming substrate to form an aerosol.

FIG. 5 shows a schematic circuit diagram of part of the control circuitry 70 of the resistively heated aerosol-generating system of FIGS. 4A and 4B in more detail. The circuit 74 of FIG. 5 is used for driving the heater assembly 112 of the aerosol-generating device 160 of FIGS. 4A and 4B and for determining one or more electrical parameters of a resistive heater, that is, the first heating element 116 and the second heating element 118 of the aerosol-generating device 160 of FIGS. 4A and 4B.

The circuit 200 includes a resistive heater R_{H} comprising the first heating element 116 and the second heating element 118, which is connected to an electric power supply via connection 202. The power supply provides a voltage Vin. An additional resistor R5 having a known value is inserted in series with the heater R_{H}. There is a voltage V_{Z} at the point Z in the circuit 200 between the heater R_{H} and the additional resistor R5. The voltage V_{Z} is intermediate between ground and voltage Vin.

The circuit 200 determines an electrical parameter of the heater R_{H}, in this example, the electrical resistance of the heater R_{H}. An analogue input 204 on a microcontroller MCU is used to monitor the voltage Vin provided by connection 202. An analogue input 206 on the microcontroller MCU is used to monitor the voltage V_{Z} at point Z. In order for the microprocessor MCU to measure the resistance of the heater R_{H}, the current through the heater R_{H} and the voltage across the heater R_{H} are determined. Ohm's law is then used to determine the resistance R_{H}.

The voltage across the heater R_{H} is Vin-V_{Z} and the current through the heater R_{H} is I. Thus, the resistance of the heater R_{H} can be determine by equation 4:

$${R}_{H} ( V in - {V}_{Z} ) / I \qquad ( 4 )$$

The current through the resistor R5 is the same as the current through the heater R_{H} because they are connected in series. That is, the current through resistor R5 and the current through the heater R_{H} is current I. As mentioned above, resistor R5 has a known value. Current I can also be approximated by equation 5:

$$I = {V}_{Z} / R 5 \qquad ( 5 )$$

So, combining (4) and (5) gives:

$${R}_{H} = ( ( V in - {V}_{Z} ) / {V}_{Z} ) \times R 5 \qquad ( 6 )$$

Thus, the microprocessor MCU can measure Vin and V_{Z}, as the aerosol generating system is being used and, knowing the value of resistor R5, can determine the resistance of the heater R_{H} at a particular temperature.

As mentioned above, the resistance of the heater R_{H} is related to temperature. If needed, a linear approximation can be used to determine the temperature T corresponding to the measured resistance R_{H} according to the following formula:

$$T = ( {R}_{H} / ( {AR}_{0} ) ) + {T}_{0} - 1 / A \qquad ( 7 )$$

where A is the thermal resistivity coefficient of the heater material and R₀ is the resistance of the heater at ambient temperature T₀.

FIG. 6 is a flow diagram of a method 300 for controlling an overheating or dry heating situation in an aerosol-generating system according to an example of the present disclosure. The method starts at step 302 when the device is activated, that is, by a user taking a puff on the aerosol-generating system. The user puff may be detected, for example, by the airflow sensor 63 in the aerosol-generating devices 60, 160 of FIGS. 1A, 1B, 4A and 4B. Upon detection of a user puff, the control circuitry of the aerosol-generating system provides a supply of power to the heating element, that is, the susceptor elements 16, 18 of the inductively heated aerosol-generating device 60 of FIGS. 1A and 1B and the heating elements 116, 118 of the resistively heated aerosol-generating device 160 of FIGS. 4A and 4B.

In step 304, the method 300 monitors an electrical parameter of the heating element that is indicative of the temperature of the heating element to detect whether an overheating or dry heating situation has arisen. The electrical parameter can be monitored using the circuits in FIGS. 3 and 5. In an inductively heated aerosol-generating system, the electrical parameter may be an equivalent resistance of the induction coil, as described above with respect to the circuit of FIG. 3. In a resistively heated aerosol-generating system, the electrical parameter may be a resistance of the heating element, as described above with respect to the circuit of FIG. 5. In detecting whether dry heating has occurred, the method 300 determines whether a threshold temperature of the heating element has been exceeded. To do this, the method determines whether the resistance or equivalent resistance of the heating element is greater than a maximum threshold value corresponding to the threshold temperature.

If a drying heating situation is not detected, then the method 300 simply stays at step 304 and, during normal operation, constantly monitors whether a dry heating situation is occurring. If a drying heating situation is detected, then step 306 of the method 300 interrupts the supply of power from the power supply to the heating element so that the heating element is no longer being heated. The interruption of the power supply means that, even if a user attempts to take a puff on the aerosol-generating system, the airflow sensor detecting the airflow will not trigger the control circuitry to send power to the heating element.

The interruption of power needs to be maintained until the heating element has cooled to a temperature below the threshold temperature. Therefore, in step 308, the method 300 monitors the cooling of the heating element. Monitoring of the cooling of the heating element may be carried out by providing a plurality of probing pulses to the heating element and monitoring the electrical resistance or equivalent resistance of the heating element over successive probing pulses. The probing pulses have significantly less power than full power operation when the heating element is being heated and typically constitute about 5 percent of the power provided during full power operation. Such a low amount of power is not capable of heating the heating element but still provides sufficient power for the resistance or equivalent resistance of the heating element to be determined in order to provide an indication of the temperature of the heating element. The probing pulses can be applied periodically during the time the power supply is interrupted to monitor the cooling of the heating element.

Whilst the heating element is cooling, the method 300 checks to see whether the temperature of the heating element has cooled to a temperature below the maximum threshold temperature at step 310. If the temperature of the heating element has not cooled below the threshold temperature, then the method 300 returns to monitoring the cooling at step 308. If the temperature of the heating element has cooled below the threshold temperature, then the method 300 moves to step 312 where it determines whether the heating element is supplied with liquid aerosol-forming substrate.

As discussed above, a dry heating situation can arise from two different causes. The first cause is the liquid aerosol-forming substrate in the cartridge has been completely depleted and therefore no liquid aerosol-forming substrate can be supplied to the heating element. In this case, the cartridge needs to be replaced. The second cause is that the user has temporarily dried the heating element by taking a particularly strong or long puff, which exhausts the liquid aerosol-forming substrate present on the heating element at the time the puff was initiated. In this case, the cartridge is not completely depleted and the user still has a number of puffs to be consumed. Therefore, the cartridge does not need to be replaced but time needs to be allowed for the liquid aerosol-forming substrate to rewet the heating element.

If there is still liquid aerosol-forming substrate remaining, then the time taken for the heating element to cool below the maximum threshold temperature should have provided sufficient time for the heating element to be rewetted. Determining whether the heating element is supplied with liquid aerosol-forming substrate may be carried out by monitoring the rate of cooling of the heating element. A heating element being wetted by liquid aerosol-forming substrate will cool more quickly than a dry heating element.

Alternatively, determining whether the heating element is supplied with liquid aerosol-forming substrate may be carried out by providing a power pulse to the heating element and determining an electrical characteristic of the heating element. A power pulse is a full power pulse which is sufficient to start heating the heating element so that an electrical characteristic of the heating element can be determined as the heating element starts to heat. The power pulse is considerably shorter in duration than the time period power is applied to the heating element to heat the heating element during normal operation but is still long enough to determine electrical characteristics of the heating element. The electrical characteristics of a wet heating element are different to those of a dry heating element, as discussed in more detail below with respect to FIG. 8. The different electrical characteristics allow the method to determine whether liquid aerosol-forming substrate is being supplied to the heating element.

If liquid aerosol-forming substrate is being supplied to the heating element, then the supply of power to the heating element is resumed (not shown) and the method 300 returns to step 304 to continue monitoring for a dry heating situation. If the user has finished their puff whilst the power supply was interrupted then the method will return to before step 302 and wait for the device to activated again on the next puff, although this is not shown in FIG. 6. If liquid aerosol-forming substrate is not being supplied to the heating element, then the method 300 moves to step 314 and disables the power supply which prevent the aerosol-generating system from being used until the cartridge is replaced.

FIG. 7 shows three graphs a), b) and c) relating to the operation of an aerosol-generating system during a dry heating situation and during normal operation. Graph a) is a plot of resistance against time and shows a first resistance profile or curve 401 for a normal heating cycle in which the heating element is supplied with liquid aerosol-forming substrate and a second resistance profile or curve 402 for a dry heating situation. In graph a) the resistance may be an electrical resistance of a resistive heating element or an equivalent resistance of an inductor heating a susceptor and is indicative of the temperature of the heating element.

Referring to the first resistance curve 401 for a wetted heating element in graph a) of FIG. 7, a user takes a puff at time to which causes the control circuitry of the aerosol-generating system to provide a supply of power to the heating element causing the heating element to heat. As can be seen in graph a) of FIG. 7, the resistance of the heating element steadily increases as its temperature increases until it stabilises at a normal operating or aerosolization temperature at which its resistance is below a threshold resistance R_{TH} indicative of a threshold temperature of the heating element. The user finishes their puff at time t₃, at which point the supply of power to the heating element is stopped and the heating element starts to cool, as shown by a steady decrease in the resistance of first resistance curve 401 after time t₃.

Graph b) of FIG. 7 is a plot of power against time for the normal heating cycle illustrated in the first resistance curve 401 in graph a) of FIG. 7. When a user takes a puff at time t₀, the control circuitry of the aerosol-generating system provides a constant supply of power to the heat the heating element, as illustrated by first power curve 403 in graph b). The supply of power to the heating element is stopped at time t₃ when a user finishes their puff.

Referring to the second resistance curve 402 for a dry heating element in graph a) of FIG. 7, a user takes a puff at time to which causes the control circuitry of the aerosol-generating system to provide a supply of power to the heating element causing the heating element to heat. As can be seen in graph a) of FIG. 7, the resistance of the heating element in the second resistance curve 402 increases more rapidly than in the first resistance curve 401 because the heating element is dry and no heat is being transferred to the liquid aerosol-forming substrate. The second resistance curve 402 exceeds the threshold resistance R_{TH} at time t₁ indicating that the heating element has exceeded a threshold temperature and a dry heating situation has occurred.

In accordance with the method of the present disclosure, the supply of power to the heating element is interrupted at time t₁ to allow the heating element to cool. However, due to a time lag in the heating element responding the temperature and resistance of the heating element continues to increase for a short period of time before the heating element starts to cool. The heating element cools to a temperature at which the resistance is below the threshold resistance R_{TH} at time t₂, indicating that the heating element has cooled to a temperature below the threshold temperature. As can be seen in graph a) of the FIG. 7, the resistance of the heating element decreases at a slower rate for a dry heating element as shown by the second resistance curve 402 than it does for a wet heating element as shown by the first resistance curve 401, indicating that the rate of cooling in a dry heating situation is less than that for a heating element that is supplied with liquid aerosol-forming substrate. This characteristic can be used to determine whether the heating element is supplied with liquid aerosol-forming substrate.

Graph c) of FIG. 7 is a plot of power against time for the dry heating situation illustrated in the second resistance curve 402 in graph a) of FIG. 7. When a user takes a puff at time t₀, the control circuitry of the aerosol-generating system provides a constant supply of power to the heat the heating element, as illustrated by second power curve 404 in graph b). As can be seen in graph c), the supply of power to the heating element is interrupted at time t₁ when the resistance of the heating element exceeds the threshold resistance R_{TH} in graph a) of FIG. 7 to allow the heating element to cool. Whilst the power is interrupted, a plurality of probing pulses 405 are provide to the heating element to periodically determine the resistance of the heating element and hence its temperature so that the cooling of the heating element can be monitored, as described above with respect to FIG. 6. The resistance of the heating element is determined during a probing pulse 405 in the same way it is determined whilst monitoring for a dry heating situation, that is, using the methods described with respect to the circuits of FIGS. 3 and 5. The probing pulses have a duration Δtₚ and there is a time interval Δtᵢ between each probing pulse. The duration of the probing pulses 405 and the intervals between probing pulses can be varied to change the resolution with which temperature is monitored.

A probing pulse 405 which occurs at time t₂ determines that the resistance of the heating element has fallen below the threshold resistance R_{TH} indicating that temperature of the heating element is now below the threshold temperature, as shown by the second resistance curve 402 in graph a) of FIG. 7. The aerosol-generating system now seeks to determine whether liquid aerosol-forming substrate is supplied to the heating element. It can do this by monitoring the rate of cooling of the heating element. As mentioned above, the rate of cooling in a dry heating situation is less than that for a heating element that is supplied with liquid aerosol-forming substrate, as shown in graph a) of FIG. 7. It should be noted in graph a) of FIG. 7 that the resistance of the second resistance profile 402 continues to decrease gradually, that is, the rate of cooling does not increase at any point, which indicates that the liquid aerosol-forming substrate is completely depleted and the cartridge needs to be replaced.

Instead of monitoring the rate of cooling of the heating element, the example of FIG. 7 uses a power pulse 406 to determine whether liquid aerosol-forming substrate is supplied to the heating element. As described above with reference to FIG. 6, a power pulse is a full power pulse which is sufficient to start heating the heating element so that an electrical characteristic of the heating element can be determined as the heating element starts to heat. The heating effect of a power pulse is not significant and therefore is not shown in graph a) of FIG. 7. The power pulse 406 is provided to the heating element in the time period between time t₂ and t₃, that is, once the temperature of the heating element has decreased below the threshold temperature. The electrical characteristics of a heating element during a power pulse used to distinguish between a heating element being supplied with liquid aerosol-forming substrate and one which is not are described below with reference to FIG. 8.

FIG. 8 is a graph of resistance against time showing the resistance of a heating element during a power pulse which can be used to determine whether the heating element is supplied with liquid aerosol-forming substrate. The resistance may be an electrical resistance of a resistive heating element or an equivalent resistance of an inductor heating a susceptor and is indicative of the temperature of the heating element. The graph of FIG. 8 shows a first resistance profile or curve 501 for a dry heating element and a second resistance profile or curve 502 for a wet heating element. If the heating element is dry, when the control circuitry of an aerosol-generating system delivers a power pulse to the heating element, which power pulses comprises a certain amount of energy, the temperature and resistance of the heating element increases rapidly, as shown in the first resistance curve 501. If the heating element is wet, then the same power pulse will result in a much slower increase in temperature and resistance, as shown in the second resistance curve 502. Consequently, based on the rate of change of resistance, it is possible to distinguish between a wet or dry heating element and whether liquid aerosol-forming substrate is being supplied to the heating element. This approach monitors the thermal mass of the heating element. A wet heating element has a greater thermal mass than a dry heating element and hence its temperature will increase more slowly in response to energy being imparted to the heating element. By monitoring the thermal mass of the heating element during operation, it is possible to determine whether the heating element has only been temporarily dried or whether the supply of liquid aerosol-forming substrate has been exhausted.

Electrical characteristics of the heating element which can be used to determine whether liquid is being supplied to the heating element include, but are not limited to: monitoring a resistance of the heating element after a predetermined elapsed time; monitoring a rate of change of the resistance of the heating element at a predetermined time; and monitoring a resistance of the heating element once a predetermined rate of change of the resistance has been reached. Furthermore, the general shape of the resistance curves 501 and 502 can be used to determine whether liquid is supplied to the heating element, for example, by storing data values in a memory, and determining which curve the measure resistance is a best fit to.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number A is understood as A±5 percent (5%) of A. Within this context, a number A may be considered to include numerical values that are within general standard error for the measurement of the property that the number A modifies. The number A, in some instances as used in the appended claims, may deviate by the percentages enumerated above provided that the amount by which A deviates does not materially affect the basic and novel characteristic(s) of the claimed invention. Also, all ranges include the maximum and minimum points disclosed and include any intermediate ranges therein, which may or may not be specifically enumerated herein.

1.-15. (canceled)

16. A method of controlling heating in an aerosol-generating system comprising a heating element configured to heat a liquid aerosol-forming substrate supplied to the heating element, the method comprising:
providing a supply of power to the heating element;
monitoring an electrical parameter indicating a temperature of the heating element;
determining whether the electrical parameter is greater than a maximum threshold value or less than a minimum threshold value indicating that a threshold temperature of the heating element has been exceeded;
interrupting the supply of power to the heating element when the threshold temperature is exceeded to allow the heating element to cool to a temperature at which the electrical parameter is below the maximum threshold value or above the minimum threshold value;
following cooling, determining whether the heating element is supplied with the liquid aerosol-forming substrate; and
disabling the supply of power if the heating element is not supplied with the liquid aerosol-forming substrate.

17. The method according to claim 16,
further comprising determining an initial value of the electrical parameter,
wherein the step of determining whether the electrical parameter is greater than the maximum threshold value or less than the minimum threshold value comprises determining whether a ratio between the initial value and a change in the value of the monitored electrical parameter is greater than the maximum threshold value or less than the minimum threshold value.

18. The method according to claim 16, further comprising resuming the supply of power if the heating element is supplied with the liquid aerosol-forming substrate.

19. The method according to claim 16, further comprising a step of detecting a user puff before providing the supply of power to the heating element.

20. The method according to claim 16,
wherein the step of monitoring the electrical parameter comprises monitoring an electrical resistance of the heating element, and
the method further comprises determining whether the electrical resistance is greater than a maximum threshold value indicating that the threshold temperature of the heating element has been exceeded.

21. The method according to claim 20,
wherein the aerosol-generating system is an inductive aerosol-generating system comprising an inductor and the heating element is a susceptor arranged to be heated by the inductor, and
wherein the step of monitoring the electrical resistance of the heating element comprises monitoring an equivalent resistance of the inductor.

22. The method according to claim 16, further comprising a step of monitoring cooling of the heating element.

23. The method according to claim 22, wherein the step of monitoring of the cooling of the heating element comprises providing a probing pulse to the heating element and determining an electrical resistance of the heating element during the probing pulse.

24. The method according to claim 22, wherein the step of monitoring of the cooling of the heating element comprises providing a plurality of probing pulses to the heating element and monitoring an electrical resistance of the heating element over successive probing pulses.

25. The method according to claim 16, wherein the step of determining whether the heating element is supplied with liquid aerosol-forming substrate comprises monitoring a rate of cooling of the heating element.

26. The method according to claim 16, wherein the step of determining whether the heating element is supplied with liquid aerosol-forming substrate comprises providing a power pulse to the heating element and determining an electrical characteristic of the heating element, the electrical characteristic being selected from one or more of the following:
a resistance of the heating element after a predetermined elapsed time,
a rate of change of the resistance of the heating element at a predetermined time, and
a resistance of the heating element once a predetermined rate of change of the resistance has been reached.

27. An aerosol-generating system, comprising:
an aerosol-generating device; and
a cartridge comprising a liquid storage portion configured to hold a liquid aerosol-forming substrate and a heating element configured to heat the liquid aerosol-forming substrate,
wherein the cartridge is configured to supply the liquid aerosol-forming substrate to the heating element and to be removably couplable to the aerosol-generating device, and
wherein the aerosol-generating device comprises a power supply configured to supply electrical power to the heating element and control circuitry configured to
control a supply of power to the heating element,
provide a supply of power to the heating element,
monitor an electrical parameter indicating a temperature of the heating element,
determine whether the electrical parameter is greater than a maximum threshold value or less than a minimum threshold value indicating that a threshold temperature of the heating element has been exceeded,
interrupt the supply of power to the heating element when the threshold temperature is exceeded to allow the heating element to cool to a temperature at which the electrical parameter is below the maximum threshold value or above the minimum threshold value,
following cooling, determine whether the heating element is supplied with the liquid aerosol-forming substrate, and
disable the power supply if the heating element is not supplied with the liquid aerosol-forming substrate.

28. The aerosol-generating system according to claim 27,
wherein monitoring the electrical parameter comprises monitoring an electrical resistance of the heating element, and
wherein the control circuitry is further configured to determine whether the electrical resistance is greater than the maximum threshold value indicating that the threshold temperature of the heating element has been exceeded.

29. The aerosol-generating system according to claim 28,
wherein the aerosol-generating device is an inductive aerosol-generating device comprising an inductor and the heating element is a susceptor arranged in the cartridge to be heated by the inductor, and
wherein monitoring the electrical resistance comprises monitoring an equivalent resistance of the inductor.

30. The aerosol-generating system according to claim 27, wherein the aerosol-generating device is configured to disable the power supply until the cartridge is replaced or the liquid aerosol-forming substrate in the liquid storage portion is replenished.
